(19) United States
(12) Patent Application Publication
(10) Pub. No.: US 2026/0086366 A1
(43) Pub. Date: Mar. 26, 2026

(54) OPTICAL COUPLER, OPTICAL COUPLING MEMBER, OPTICAL COUPLING MEMBER WITH OPTICAL MODULATION FUNCTION, VISIBLE LIGHT SOURCE MODULE, OPTICAL ENGINE AND XR GLASSES

(71) Applicant: TDK CORPORATION, Tokyo (JP)

(72) Inventors: Yasuhiro TAKAGI, Tokyo (JP); Hiroki HARA, Tokyo (JP); Atsushi SHIMURA, Tokyo (JP)

(73) Assignee: TDK CORPORATION, Tokyo (JP)

(21) Appl. No.: 19/218,765

(22) Filed: May 27, 2025

(30) Foreign Application Priority Data
May 31, 2024 (JP) 2024-088640

(51) Int. Cl. G02B 27/01; G02B 6/28; G02F 1/035; G02F 1/21

(52) U.S. Cl. CPC G02B 27/0172; G02B 6/2813; G02F 1/035; G02F 1/212; G02B 2027/0112; G02B 2027/0178; G02F 2202/20

(57) ABSTRACT

An optical coupler of the present disclosure couples laser light beams with a plurality of different wavelengths, and includes an MMI connected optical coupling unit formed by connecting a first MMI type optical coupling element that shifts an incidence position and a second MMI type optical coupling element having a width wider than the width of the first MMI type optical coupling element, one or more first light input side optical waveguides that are connected to the first MMI type optical coupling element, one or more second light input side optical waveguides that are connected to the second MMI type optical coupling element and one light output side optical waveguide that is connected to the second MMI type optical coupling element.

### CROSS-REFERENCE TO RELATED APPLICATION

Priority is claimed on Japanese Patent Application No. 2024-088640, filed May 31, 2024, the content of which is incorporated herein by reference.

### BACKGROUND OF THE INVENTION

### Field of the Invention

The present invention relates to an optical coupler, an optical coupling member, an optical coupling member with an optical modulation function, a visible light source module, an optical engine and XR glasses.

### Description of Related Art

Eyeglasses-type terminals are currently being considered for VR and AR. Particularly, in recent years, retina scanning displays that form an image on a user's retina with two-dimensionally scanned light and allow the user to view the image have been focused on. In the retina scanning displays, generally, three colors of visible light beams emitted from light sources such as light emitting diodes (LEDs) and laser diodes (LDs) corresponding to respective colors of R (red), G (green), and B (blue) are coupled on a single optical axis. The coupled three-color visible light is transmitted to an image display unit. The image display unit two-dimensionally scans the transmitted light and allows it to enter the user's pupil. The incidence light forms an image on the user's retina and thus the user views the image.

For example, Patent Document 1 discloses the configuration of a retina projection type display using a Mach-Zehnder type optical modulator.

### PATENT DOCUMENTS

[Patent Document 1] Japanese Patent No. 6728596
[Patent Document 2] Japanese Patent No. 6787397
[Patent Document 3] Japanese Patent No. 6572377
[Patent Document 4] Japanese Unexamined Patent Application, First Publication No. 2012-48071
[Patent Document 5] Japanese Unexamined Patent Application, First Publication No. 2020-27170

### SUMMARY OF THE INVENTION

In the retina projection type display disclosed in Patent Document 1, a plurality of optical waveguides are close to each other at an emission unit, but light beams are not coupled, the optical axis differs for each wavelength, and control of the emitted light becomes complicated.

In addition, there is a demand for an optical coupler that can be connected to or integrated with a visible light modulator and can adjust the RGB color balance, but this is currently not being considered at all.

However, in Patent Document 1, the optical waveguides are simply brought close to each other at the emission unit, and the light beams are not coupled. Therefore, the optical axis for each wavelength differs, and thus control of the emitted light becomes complicated.

In addition, Patent Document 2 discloses a visible light modulator using a lithium niobate film. An RGB optical coupler that can be connected to or integrated with a visible light modulator using a lithium niobate film is required, but this has not yet been considered.

For visible light coupling, a directional coupler is generally considered (for example, refer to Patent Document 3). This coupler is made of a glass material and has excellent stability, but when a lithium niobate substrate with a large Δn is used, the coupling length becomes long and size reduction is not possible.

Patent Document 4 and Patent Document 5 disclose configurations of RGB couplers using a multimode interferometer (MMI), but in both configurations, a glass material is used, and no configuration using a lithium niobate film is disclosed at all.

An MMI type optical coupler receives a plurality of input signals using a plurality of waveguide ports on the light input side, uses a single waveguide port for the output signal on the light output side, couples all input signals, and outputs them as an output signal.

The MMI type optical coupler is an optical coupler that utilizes a characteristic that a plurality of modes generated for each wavelength within a wide optical coupler interfere with each other, and an image is formed (converges) at a specific position.

The present disclosure has been made in view of the above circumstances and an object of the present disclosure is to provide an optical coupler that can be connected to or integrated with an optical modulator using a lithium niobate film, can be made smaller than conventional ones and has a reduced light loss, an optical coupling member, an optical coupling member with an optical modulation function, a visible light source module and an optical engine.

In order to achieve the above object, the present disclosure provides the following aspects.

Aspect 1 of the present disclosure is an optical coupler that couples laser light beams with a plurality of different wavelengths, including:
from the input side, an MMI connected optical coupling unit formed by connecting a first MMI type optical coupling element that shifts an incidence position and a second MMI type optical coupling element having a width wider than the width of the first MMI type optical coupling element;
one or more first light input side optical waveguides that are connected to the first MMI type optical coupling element;
one or more second light input side optical waveguides that are connected to the second MMI type optical coupling element; and
one light output side optical waveguide that is connected to the second MMI type optical coupling element.

Aspect 2 of the present disclosure is the optical coupler of Aspect 1, wherein the first light input side optical waveguide, the second light input side optical waveguide and the light output side optical waveguide all have a tapered part whose width increases continuously toward the MMI connected optical coupling unit.

Aspect 3 of the present disclosure is the optical coupler of Aspect 1 or 2, wherein the number of first light input side optical waveguides is two.

Aspect 4 of the present disclosure is the optical coupler according to any one of Aspects 1 to 3, wherein the width of the first MMI type optical coupling element is ⅔ of the width of the second MMI type optical coupling element or less.

Aspect 5 of the present disclosure is the optical coupler according to any one of Aspects 1 to 4, wherein the length of the first MMI type optical coupling element is 2 μm or more.

Aspect 6 of the present disclosure is the optical coupler according to any one of Aspects 1 to 5, wherein the plurality of different wavelengths are all visible light wavelengths.

Aspect 7 of the present disclosure is an optical coupling member including a substrate made of a material different from lithium niobate and a lithium niobate film formed on the main surface of the substrate, wherein the optical coupler according to any one of Aspects 1 to 6 is formed on the lithium niobate film.

Aspect 8 of the present disclosure is a visible light source module including the optical coupling member of Aspect 7 and a plurality of visible laser light sources that emit visible light beams that are coupled by the optical coupling member.

Aspect 9 of the present disclosure is an optical coupling member with an optical modulation function including the optical coupling member of Aspect 7, and a Mach-Zehnder type optical modulator that is connected to the optical coupling member and guides a plurality of visible light beams emitted from a plurality of visible laser light sources to the optical coupler.

Aspect 10 of the present disclosure is a visible light source module including the optical coupling member with an optical modulation function of Aspect 9 and a plurality of visible laser light sources that emit visible light beams that are coupled by the optical coupling member with an optical modulation function, wherein the plurality of visible laser light sources are visible laser light sources for red light, green light, and blue light.

Aspect 11 of the present disclosure is an optical engine including the visible light source module of Aspect 8 and an optical scanning mirror that reflects light emitted from the visible light source module at different angles so that an image is displayed.

Aspect 12 of the present disclosure is an optical engine including the visible light source module of Aspect 10 and an optical scanning mirror that reflects light emitted from the visible light source module at different angles so that an image is displayed.

Aspect 13 of the present disclosure is XR glasses in which the optical engine of Aspect 11 is mounted.

Aspect 14 of the present disclosure is XR glasses in which the optical engine of Aspect 12 is mounted.

According to the present invention, it is possible to provide an optical coupler that can be connected to or integrated with an optical modulator using a lithium niobate film, can be made smaller than conventional ones and has a reduced light loss.

### BRIEF DESCRIPTION OF THE DRAWINGS

FIG. 1 is a schematic plan view showing an example of an optical coupler according to the present disclosure.

FIG. 2 is a schematic plan view showing another example of the optical coupler according to the present disclosure.

FIG. 3 is a schematic plan view showing another example of the optical coupler according to the present disclosure.

FIG. 4 is a schematic plan view showing another example of the optical coupler according to the present disclosure.

FIG. 5 is a schematic plan view showing another example of the optical coupler according to the present disclosure.

FIG. 6 is a schematic plan view showing another example of the optical coupler according to the present disclosure.

FIG. 7A is a diagram for explaining the principle of an MMI type optical coupler, and is a conceptual diagram showing the relationship between a width WM and an effective width We of the optical coupler, and a single mode and a higher-order mode.

FIG. 7B is a diagram for explaining the principle of the MMI type optical coupler, and is a diagram showing the simulation results of an electromagnetic field distribution in the cross section of a waveguide in each of a single mode (TM0), a higher-order mode (TM1), and a higher-order mode (TM2).

FIG. 8A is a diagram for explaining the principle of the MMI type optical coupler, and shows the results of a simulation of the electromagnetic field distribution of red (R) light.

FIG. 8B is a diagram for explaining the principle of the MMI type optical coupler, and shows the results of a simulation of the electromagnetic field distribution of green (G) light.

FIG. 9A shows the graphs of the relationship between the lengths and beat lengths of a first MMI type optical coupling element and a second MMI type optical coupling element, and the output intensity for red (R) laser light.

FIG. 9B shows the graphs of the relationship between the lengths and beat lengths of the first MMI type optical coupling element and the second MMI type optical coupling element, and the output intensity for green (G) laser light.

FIG. 10 is a schematic plan view of an optical coupling member according to the present disclosure.

FIG. 11 is a cross-sectional schematic diagram of the optical coupling member shown in FIG. 10 taken along the line X-X′.

FIG. 12 is a cross-sectional schematic diagram cut along the YZ plane when the cross section of an MMI type optical coupling element has a trapezoidal shape, and a slab part is provided on the side of a substrate.

FIG. 13 is a schematic plan view of an optical coupling member with an optical modulation function according to the present disclosure.

FIG. 14 is a schematic plan view of a visible light source module according to the present disclosure.

FIG. 15 is a cross-sectional schematic diagram of a part of the light source module shown in FIG. 14 cut along the XZ plane, and shows only a part in the vicinity of a bonding part.

FIG. 16A is a diagram for explaining an example of an optical modulator driving method.

FIG. 16B is a diagram for explaining another example of the optical modulator driving method.

FIG. 16C is a diagram for explaining another example of the optical modulator driving method.

FIG. 17 is a schematic plan view of the visible light source module according to the present disclosure.

FIG. 18 is a conceptual diagram for explaining an example of XR glasses of the present invention.

FIG. 19 is a conceptual diagram showing a state in which an image is directly projected onto the retina with laser light beams emitted from the light source module in XR glasses shown in FIG. 18.

FIG. 20 is a diagram showing parameters of a model used in a simulation.

FIG. 21 is a diagram showing parameters of another model used in a simulation.

FIG. 22A is a graph for an example showing a horizontal axis that represents the length L2 of a first MMI type optical coupling main part and a vertical axis that represents the loss in the light intensity after light beams for each RGB wavelength passed through an MMI connected optical coupling unit.

FIG. 22B is a graph for a comparative example showing a horizontal axis that represents the length L2 of the first MMI type optical coupling main part and a vertical axis the represents the loss in the light intensity after light beams for each RGB wavelength passed through the MMI connected optical coupling unit.

### DETAILED DESCRIPTION OF THE INVENTION

The present disclosure will be appropriately described below in detail with reference to the drawings. In the drawings used in the following description, in order to facilitate understanding features, feature parts are enlarged for convenience of illustration in some cases, and size ratios and the like between components may be different from those of actual components. Materials, sizes and the like exemplified in the following description are examples, and the present invention is not limited thereto, and they can be appropriately changed within a range in which the effects of the present invention are obtained.

### [Optical Coupler]

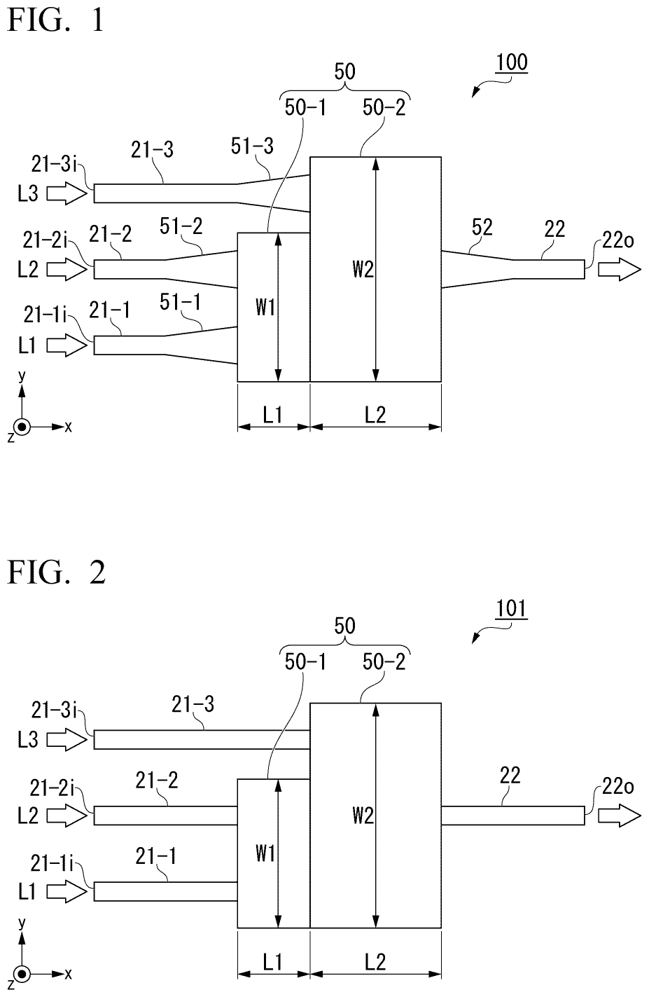

FIG. 1 is a schematic plan view showing an example of an optical coupler according to the present disclosure. FIG. 2 is a schematic plan view showing another example of the optical coupler according to the present disclosure.

The optical coupler according to the present disclosure is a multimode interference (MMI) type optical coupler.

In this specification, an optical coupling element formed by connecting components with different sizes (rectangular components in a plan view) as shown in FIG. 1 is referred to as an “MMI connected optical coupling unit.” The components (rectangular components in a plan view) constituting the MMI connected optical coupling unit may be referred to “optical coupling elements.” On the other hand, an optical coupling element composed of one rectangular component may be referred to as an “MMI single type optical coupling unit.” The MMI single type optical coupling unit is composed of one optical coupling element. The MMI connected optical coupling unit and the MMI single type optical coupling unit may be collectively referred to as an MMI type optical coupling unit.

In addition, an optical coupling element in which the MMI single type optical coupling unit or the MMI connected optical coupling unit is linked via an optical waveguide may be referred to as an “MMI linked optical coupling unit.” In addition, regarding the “MMI linked optical coupling unit,” depending on the number of optical waveguides for link, a configuration in which two MMI single type optical coupling units or MMI connected optical coupling units are linked may be referred to as a two-stage MMI linked optical coupling unit (or simply a two-stage MMI type optical coupling unit), a configuration in which three MMI single type optical coupling units or MMI connected optical coupling units are linked may be referred to as a three-stage linked optical coupling unit (or simply a three-stage MMI type optical coupling unit), and a configuration in which multiple MMI single type optical coupling units or MMI connected optical coupling units are linked may be referred to as a multiple-stage linked optical coupling unit (or simply a multiple-stage MMI type optical coupling unit). A configuration without link may be referred to as a one-stage MMI single type optical coupling unit or a one-stage MMI optical coupling unit. The one-stage MMI single type optical coupling unit and the one-stage MMI optical coupling unit may be collectively referred to as a one-stage MMI type optical coupling unit.

An optical coupler 100 shown in FIG. 1 is an optical coupler that couples laser light beams with three different wavelengths, and includes, from the input side, an MMI connected optical coupling unit 50 formed by connecting a first MMI type optical coupling element 50-1 that shifts the incidence position, and a second MMI type optical coupling element 50-2 having a width W2 wider than a width W1 of the first MMI type optical coupling element 50-1, two first light input side optical waveguides 21-1 and 21-2 connected to the first MMI type optical coupling element 50-1, one second light input side optical waveguide 21-3 connected to the second MMI type optical coupling element 50-2, and one light output side optical waveguide 22 connected to the second MMI type optical coupling element 50-2.

The optical coupler 100 is a 3×1 type (3-input port and 1-output port) optical coupler including three light input ports (a first light input port 21-1i, a second light input port 21-2i, and a third light input port 21-3i) and one light output port 22o.

In FIG. 1, the X direction is a direction in which the first light input side optical waveguide and the second light input side optical waveguide extend, the Y direction is a direction perpendicular to the X direction, and the Z direction is a direction perpendicular to the plane formed by the X direction and the Y direction.

The first MMI type optical coupling element 50-1 is an element provided for shifting the position of laser light beams incident on the second MMI type optical coupling element 50-2 to the light input side.

The first MMI type optical coupling element 50-1 can be rephrased as an MMI type optical coupling incidence position shift element, and the second MMI type optical coupling element 50-2 can be rephrased as an MMI type optical coupling main part. In this case, the MMI connected optical coupling unit 50 is formed by connecting the MMI type optical coupling main part and the MMI type optical coupling incidence position shift element on the light input side.

When laser light beams with different wavelengths are coupled from the same incidence end surface, the loss margin for the length and width of the MMI type optical coupling element depends on the wavelength, but the dependence of the loss margin on the wavelength is improved by changing the position of the incidence end surface (simply referred to as an “incidence position”).

Some of a plurality of laser light beams input from the outside enter the first MMI type optical coupling element, and the remaining laser light beams enter the second MMI type optical coupling element.

In the optical coupler 100 shown in FIG. 1, among three laser light beams, two laser light beams (laser light beams L1 and L2) enter the first MMI type optical coupling element 50-1, and one laser light beam (laser light beam L3) enters the second MMI type optical coupling element 50-2. While the laser light beam L3 enters the second MMI type optical coupling element 50-2, the laser light beams L1 and L2 enter the first MMI type optical coupling element 50-1, and thus the positions of the laser light beams L1 and L2 incident on the MMI connected optical coupling unit 50 are shifted by the length L1 of the first MMI type optical coupling element 50-1 with respect to the laser light beam L3. When the incidence positions of some laser light beams among a plurality of laser light beams to be optically coupled are shifted, the dependence of the loss margin on the wavelength can be improved.

The optical coupler 100 shown in FIG. 1 is configured to shift the incidence positions of two laser light beams L1 and L2 among three laser light beams to the light input side, but may be configured to shift only the incidence position of one laser light beam to the light input side. The number of light beams whose incidence positions are to be shifted among a plurality of laser light beams can be appropriately selected according to the dependence of the loss margin on the wavelength for the length and width of the MMI type optical coupling element.

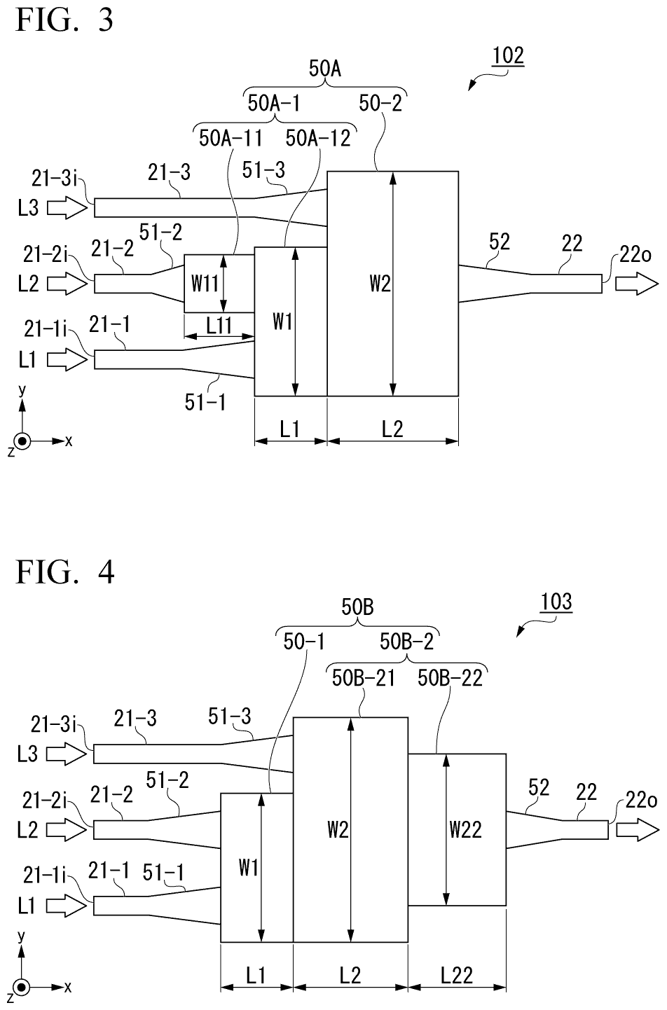

The first MMI type optical coupling element 50-1 as an MMI type optical coupling incidence position shift element is an MMI single type optical coupling element composed of one rectangular component in a plan view, but may be an MMI connected optical coupling unit formed by connecting components with different sizes (rectangular components in a plan view) (refer to FIG. 3). On the other hand, in the optical coupler 100, the second MMI type optical coupling element 50-2 as an MMI type optical coupling main part is an MMI single type optical coupling element composed of one rectangular component in a plan view, but may be an MMI connected optical coupling unit formed by connecting components with different sizes (rectangular components in a plan view).

The width W1 of the first MMI type optical coupling element 50-1 may be ⅔ of the width W2 of the second MMI type optical coupling element 50-2 or less. In addition, the width W1 of the first MMI type optical coupling element 50-1 may be ⅓ of the width W2 of the second MMI type optical coupling element 50-2 or more.

The length L1 of the first MMI type optical coupling element 50-1 is preferably 2 μm or more. If the length L1 is 2 μm or more, the dependence of the loss margin on the wavelength can be improved. The upper limit of the length L1 of the first MMI type optical coupling element 50-1 may be, for example, 2 to 200 μm.

The length L2 of the second MMI type optical coupling element 50-2 is preferably 10 μm or more. The upper limit of the second MMI type optical coupling element 50-2 may be, for example, 10 to 3000 μm.

The width W1 of the first MMI type optical coupling element 50-1 may be, for example, 1 to 10 μm.

The width W2 of the second MMI type optical coupling element 50-2 may be, for example, 3 to 20 μm.

In the optical coupler 100 shown in FIG. 1, the two light input side optical waveguides 21-1 and 21-2 have tapered parts 51-1 and 51-2 with tapered shapes whose width increases continuously toward the first MMI type optical coupling element 50-1 at a part connected to the first MMI type optical coupling element 50-1 and whose inclination angle can be defined, and one light input side optical waveguide 21-3 has a tapered part 51-3 with a tapered shape whose width increases continuously toward the second MMI type optical coupling element 50-2 at a part connected to the second MMI type optical coupling element 50-2 and whose inclination angle can be defined. In addition, one light output side optical waveguide 22 has a tapered part 52 with a tapered shape whose width increases continuously toward the second MMI type optical coupling element 50-2 at a part connected to the second MMI type optical coupling element 50-2 and whose inclination angle can be defined.

When the cross section of the light input side optical waveguides 21-1, 21-2, and 21-3, and the light output side optical waveguide 22 perpendicular to the extension direction has a rectangular shape or trapezoidal shape (the upper base is smaller than the lower base), for example, when the width of the upper surface of the light input side optical waveguides 21-1, 21-2, and 21-3, and the light output side optical waveguide 22 is 0.3 to 1.2 μm, the starting width of the tapered parts 51-1, 51-2, 51-3, and 52 may be 0.3 to 1.2 μm, the width of the part connected to the MMI type optical coupling element may be, for example, 0.5 to 2.5 μm, and the length of the tapered part may be, for example, 10 to 500 μm.

When a tapered part is provided at the input/output port connected to the MMI type optical coupling element, the following effects are obtained. The light input side optical waveguide and the light output side optical waveguide connected to the MMI type optical coupling element are set to propagate a laser light beam in a single mode (zeroth mode, fundamental mode), and the MMI type optical coupling element is set to propagate a laser light beam in a multimode (zeroth mode to higher-order mode). Therefore, when light is input from the light input side optical waveguide to the MMI type optical coupling element and output from the MMI type optical coupling element to the light output side optical waveguide, a coupling loss is generated due to mode mismatch between the single mode and the multimode in which light is input. On the other hand, this is because, when a tapered part is provided at the input/output port, mode mismatch between the single mode and the multimode is alleviated, and the coupling loss is reduced. When the width of the tapered part is sufficiently wider, the mode mismatch can be largely alleviated, and the coupling loss can be largely reduced.

The optical coupler according to the present disclosure is not limited to the configuration in which the light input side optical waveguide and the light output side optical waveguide have a tapered part, but may have a configuration in which the light input side optical waveguide and the light output side optical waveguide have no tapered part as in an optical coupler 101 shown in FIG. 2.

FIG. 3 shows an optical coupler in which a first MMI type optical coupling element 50A-1 as an MMI type optical coupling incidence position shift element is an MMI connected optical coupling unit formed by connecting rectangular components with different sizes in a plan view.

An optical coupler 102 shown in FIG. 3 is an optical coupler that couples three laser light beams with different wavelengths, and includes, from the input side, an MMI connected optical coupling unit 50A formed by connecting a first MMI type optical coupling element 50A-1 as an MMI connected optical coupling unit that shifts the incidence position and a second MMI type optical coupling element 50-2 having a width W2 wider than a width W1 of the first MMI type optical coupling element 50A-1 as an MMI connected optical coupling unit, two first light input side optical waveguides 21-1 and 21-2 connected to the first MMI type optical coupling element 50A-1 as an MMI connected optical coupling unit, one second light input side optical waveguide 21-3 connected to the second MMI type optical coupling element 50-2, and one light output side optical waveguide 22 connected to the second MMI type optical coupling element 50-2.

In the optical coupler 102 shown in FIG. 3, the MMI type optical coupling incidence position shift element 50A-1 as an MMI connected optical coupling unit is an optical coupling element formed by connecting, from the input side, a first MMI type optical coupling incidence position shift element 50A-11 and a second MMI type optical coupling incidence position shift element 50A-12 having a width W1 wider than a width W11 of the first MMI type optical coupling incidence position shift element 50A-11 (an element having the same length and width as the first MMI type optical coupling element 50-1 in the optical coupler 100 shown in FIG. 1 is exemplified).

The optical coupler 102 shown in FIG. 3 is the same as the optical coupler 100 shown in FIG. 1 in that the incidence positions of two laser light beams L1 and L2 among three laser light beams are shifted to the light input side, but the optical coupler 102 shown in FIG. 3 differs from the optical coupler 100 shown in FIG. 1 in that the incidence position of one laser light beam L2 between two laser light beams L1 and L2 is shifted further toward the light input side than the incidence position of the laser light beam L1.

The optical coupler 102 shown in FIG. 3 has a configuration in which all the incidence positions of three laser light beams are different.

Different incidence positions of three laser light beams can be appropriately set according to the dependence of the loss margin on the wavelength for the length and width of the MMI type optical coupling element.

The length L11 of the first MMI type optical coupling incidence position shift element 50A-11 is preferably 2 μm or more. If the length L11 is 2 μm or more, the dependence of the loss margin on the wavelength can be improved. The upper limit of the length L11 of the first MMI type optical coupling incidence position shift element 50A-11 may be, for example, 2 to 100 μm.

The width W11 of the first MMI type optical coupling incidence position shift element 50A-11 may be, for example, 1 to 10 μm.

The optical coupler 102 is a 3×1 type (3-input port and 1-output port) optical coupler including three light input ports (the first light input port 21-1i, the second light input port 21-2i, and the third light input port 21-3i) and one light output port 22o.

FIG. 4 is a schematic plan view showing an optical coupler when a second MMI type optical coupling element 50B-2 as an MMI type optical coupling main part is an MMI connected optical coupling unit formed by connecting rectangular components with different sizes in a plan view.

An optical coupler 103 shown in FIG. 4 is an optical coupler that couples three laser light beams with different wavelengths, and includes, from the input side, an MMI connected optical coupling unit 50B formed by connecting a first MMI type optical coupling element 50-1 that shifts the incidence position and a second MMI type optical coupling element 50B-2 having a width W2 wider than a width W1 of the first MMI type optical coupling element 50A-1, two first light input side optical waveguides 21-1 and 21-2 connected to the first MMI type optical coupling element 50-1, one second light input side optical waveguide 21-3 connected to the second MMI type optical coupling element 50B-2, and one light output side optical waveguide 22 connected to the second MMI type optical coupling element 50B-2.

In the optical coupler 103 shown in FIG. 4, the second MMI type optical coupling element 50B-2 as an MMI type optical coupling main part is an optical coupling unit formed by connecting, from the input side, a first MMI type optical coupling main part 50B-21 and a second MMI type optical coupling main part 50B-22 having a width W22 narrower than a width W2 of the first MMI type optical coupling main part 50B-21 (an element having the same length and width as the second MMI type optical coupling element 50-2 in the optical coupler 100 shown in FIG. 1 is exemplified).

The optical coupler 103 shown in FIG. 4 has the same relationship among the incidence positions of three laser light beams as the optical coupler 100 shown in FIG. 1. That is, the incidence positions of two laser light beams L1 and L2 among three laser light beams are shifted to the light input side.

The length L22 of the second MMI type optical coupling main part 50B-22 is preferably 100 μm or more. The upper limit of the length L22 of the second MMI type optical coupling main part 50B-22 may be, for example, 100 to 1,000 μm.

The width W22 of the second MMI type optical coupling main part 50B-22 may be, for example, 2 to 18 μm.

The optical coupler 103 is a 3×1 type (3-input port and 1-output port) optical coupler including three light input ports (the first light input port 21-1i, the second light input port 21-2i, and the third light input port 21-3i) and one light output port 22o.

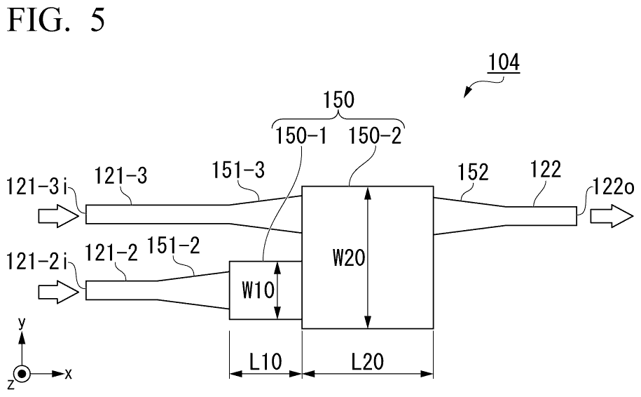

FIG. 5 is a schematic plan view showing a 2×1 type (2-input port and 1-output port) optical coupler including two light input ports (light input ports 121-2i and 121-3i) and one light output port 122o.

An optical coupler 104 shown in FIG. 5 is an optical coupler that couples two laser light beams with different wavelengths, and includes, from the input side, an MMI connected optical coupling unit 150 formed by connecting a first MMI type optical coupling element 150-1 that shifts the incidence position and a second MMI type optical coupling element 150-2 having a width W20 wider than a width W10 of the first MMI type optical coupling element 150-1, one first light input side optical waveguide 121-2 connected to the first MMI type optical coupling element 150-1, one second light input side optical waveguide 121-3 connected to the second MMI type optical coupling element 150-2, and one light output side optical waveguide 122 connected to the second MMI type optical coupling element 150-2.

The first light input side optical waveguide 121-2, the second light input side optical waveguide 121-3 and the light output side optical waveguide 122 have tapered parts 151-2, 151-3, and 152 with tapered shapes whose inclination angle can be defined, respectively.

The length L10 of the first MMI type optical coupling element 150-1 is preferably 2 μm or more. If the length L10 is 2 μm or more, the dependence of the loss margin on the wavelength can be improved. The upper limit of the length L1 of the first MMI type optical coupling element 150-1 may be, for example, 2 to 300 μm.

The length L20 of the second MMI type optical coupling element 150-2 is preferably 10 μm or more. The upper limit of the second MMI type optical coupling element 150-2 may be, for example, 10 to 1,000 μm.

The width W10 of the first MMI type optical coupling element 150-1 may be, for example, 1 to 10 μm.

The width W20 of the second MMI type optical coupling element 150-2 may be, for example, 3 to 20 μm.

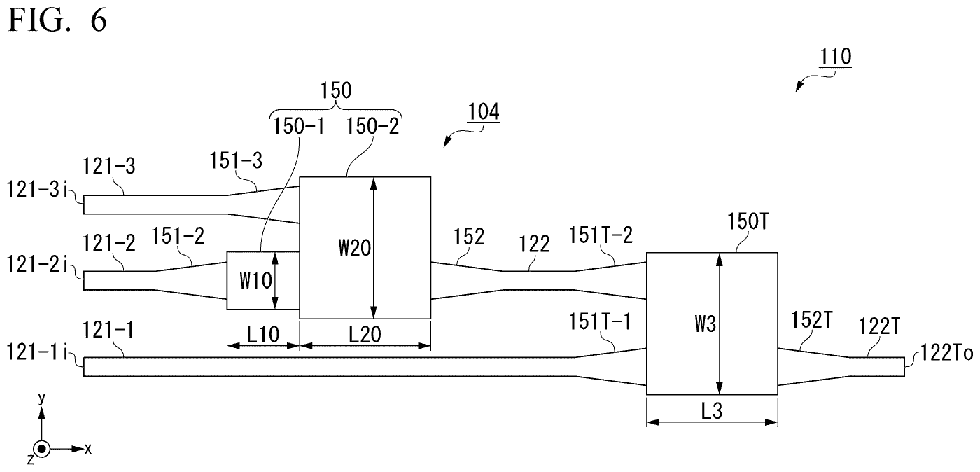

FIG. 6 is a schematic plan view of an optical coupler having the above 3×1 type MMI linked optical coupling unit including a 2×1 type MMI type optical coupler such as the optical coupler 104 shown in FIG. 5.

An optical coupler 110 shown in FIG. 6 is an optical coupler that couples three laser light beams with different wavelengths, and includes an output side MMI type optical coupling unit 150T that is linked to the MMI connected optical coupling unit 150 in addition to the optical coupler 104 shown in FIG. 5. In addition, the output side MMI type optical coupling unit 150T is linked to the MMI connected optical coupling unit 150 (more specifically, the second MMI type optical coupling element 150-2) via the light output side optical waveguide 122 as an optical waveguide for link.

The optical coupler 110 shown in FIG. 6 includes an MMI linked optical coupling unit, in which the MMI connected optical coupling unit 150 (which is formed of the first MMI type optical coupling element 150-1 as an MMI type optical coupling incidence position shift element and the second MMI type optical coupling element 150-2 as an MMI type optical coupling main part), is linked to the output side MMI type optical coupling unit 150T.

In addition, the optical coupler 110 shown in FIG. 6 includes one first light input side optical waveguide 121-2 connected to the first MMI type optical coupling element 150-1 as an MMI type optical coupling incidence position shift element, one second light input side optical waveguide 121-3 connected to the second MMI type optical coupling element 150-2, which is a part of the MMI linked optical coupling unit, a light input side optical waveguide 121-1 as one second light input side optical waveguide connected to the output side MMI type optical coupling unit 150T, which is a part of the MMI linked optical coupling unit, and one light output side optical waveguide 122T connected to the output side MMI type optical coupling unit 150T, which is a part of the MMI linked optical coupling unit.

Two light input side optical waveguides connected to the output side MMI type optical coupling unit 150T have tapered parts 151T-1 and 151T-2 with tapered shapes whose inclination angle can be defined, and one light input side optical waveguide connected to the output side MMI type optical coupling unit 150T has a tapered part 152T with a tapered shape whose inclination angle can be defined.

The optical coupler 110 shown in FIG. 6 is a 3×1 type (3-input port and 1-output port) MMI type optical coupler including three light input ports (light input ports 121-1i, 121-2i, and 121-3i) and one light output port 122To.

The length L10 of the first MMI type optical coupling element 150-1 is preferably 2 μm or more. If the length L10 is 2 μm or more, the dependence of the loss margin on the wavelength can be improved. The upper limit of the length L10 of the first MMI type optical coupling element 150-1 may be, for example, 2 to 300 μm.

The length L20 of the second MMI type optical coupling element 150-2 is preferably 10 μm or more. The upper limit of the second MMI type optical coupling element 150-2 may be, for example, 10 to 1,000 μm.

The width W10 of the first MMI type optical coupling element 150-1 may be, for example, 1 to 10 μm.

The width W20 of the second MMI type optical coupling element 150-2 may be, for example, 3 to 20 μm.

The length L3 of the output side MMI type optical coupling unit 150T is preferably 50 μm or more. The upper limit of the length L3 of the output side MMI type optical coupling unit 150T may be, for example, 50 to 1,000 am.

The width W3 of the output side MMI type optical coupling unit 150T may be, for example, 3 to 20 μm.

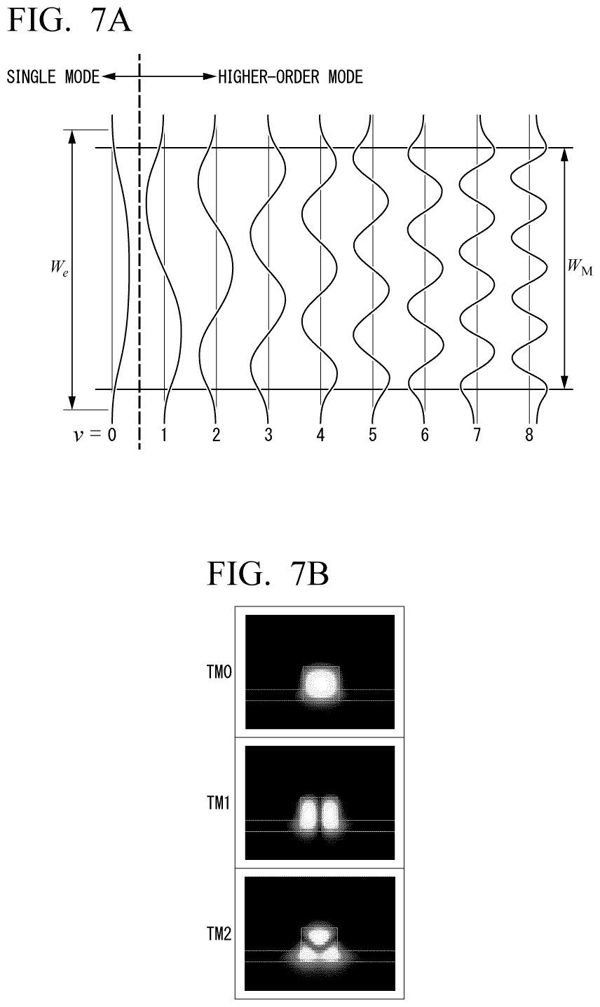

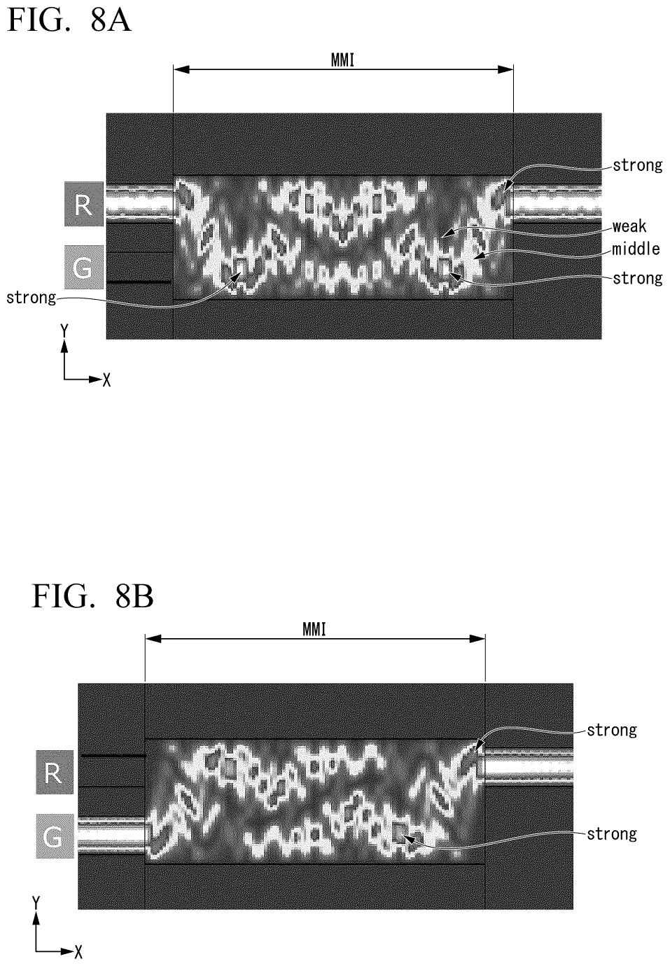

The principle of the MMI type optical coupler will be described with reference to FIG. 7A, FIG. 7B, FIG. 8A, and FIG. 8B.

FIG. 7A shows a single mode (v=0) and a higher-order mode (v≥1) generated within the width WM of the MMI type optical coupler. We is the effective width of the MMI type optical coupler, and is approximated by the effective width of the MMI type optical coupler in consideration of penetration of light in the mode and the Goos-Hänchen shift in the zeroth mode (fundamental mode). FIG. 7B is a diagram showing the simulation results of an electromagnetic field distribution in the cross section of a waveguide in each of a single mode (TM0), a higher-order mode (TM1), and a higher-order mode (TM2).

The MMI type optical coupler has a characteristic that a plurality of modes from the zeroth mode to the higher-order mode interfere with each other and an image is formed (converges) at a specific position (a predetermined distance from the input end) of the MMI type optical coupler. It is known that the distance between adjacent convergence points or the period (beat length) Lπ approximately follows Formula (1). Formula (1) is the beat length Lπ between two lower-order modes, the zeroth mode and the first mode.

$$\begin{matrix}[ Math . 1 ] & \\ {L}_{π} = \frac{π}{{β}_{0} - {β}_{1}} ≅ \frac{4 {nW}_{e}^{2}}{3 λ} & ( 1 )\end{matrix}$$

In Formula (1), We is the effective width of the MMI type optical coupler, n is the effective refractive index of the MMI type optical coupler, and λ is the wavelength of the input light. β₀ and β₁ are propagation constants in the zeroth mode and the first mode, respectively. It can be understood from Formula (1) that the beat length depends on the width and wavelength of the MMI type optical coupler.

When a phase change of 2π occurs in the electromagnetic field distribution in all propagation modes generated within the MMI type optical coupler, the light intensity distribution matches the incidence light intensity distribution. The light propagation distance required to achieve the state of match (convergence) is called a self-projection distance, and convergence is repeated at a period of LU after a certain propagation distance of 3Lπ/4.

FIG. 8A and FIG. 8B show the results of a simulation performed using simulation software (Fimmwave, commercially available from Photon Design) on the electromagnetic field distribution of a cross section of a 2×1 MMI type optical coupler (R/G coupler) in the light propagation direction (x direction). In the simulation model, the y-direction position (coordinate) of the input side waveguide at which red (R) light with a wavelength of 638 nm enters the optical coupler is the same as the y-direction position (coordinate) of the output side waveguide of the optical coupler, and the y-direction position of the input side waveguide at which green (G) light with a wavelength of 520 nm enters the optical coupler is separated by a predetermined distance. A part with a brighter color indicates a position at which the modes strongly interfere with each other (“strong” in the drawing), a part with a darker color indicates a position at which the modes do not strongly interfere with each other (“weak” in the drawing), and a part with an intermediate color indicates a position at which the degree of interference between the modes is intermediate (“middle” in the drawing).

FIG. 8A shows the results of a simulation of the electromagnetic field distribution of red (R) light, and FIG. 8B shows the results of a simulation of the electromagnetic field distribution of green (G) light.

In both FIG. 8A and FIG. 8B, there is a part in which strong interference occurs in the vicinity of the output port of the optical coupler, and it is preferable to set the length of the MMI type optical coupler (length in the X direction) so that the position matches as closely as possible (that is, the length is as close as possible to an integer multiple (least common multiple) of the beat length of each input wavelength). However, since the phase difference is influenced by the position of each input wavelength input to the optical coupler, the length of the MMI type optical coupler cannot be determined only by an integer multiple of the beat length of each input wavelength.

Therefore, the length of the optical coupler is set to an integer multiple (least common multiple) of the beat length of each input wavelength as a starting point, and should to be adjusted in consideration of the influence of the phase due to the position of each input wavelength input to the optical coupler.

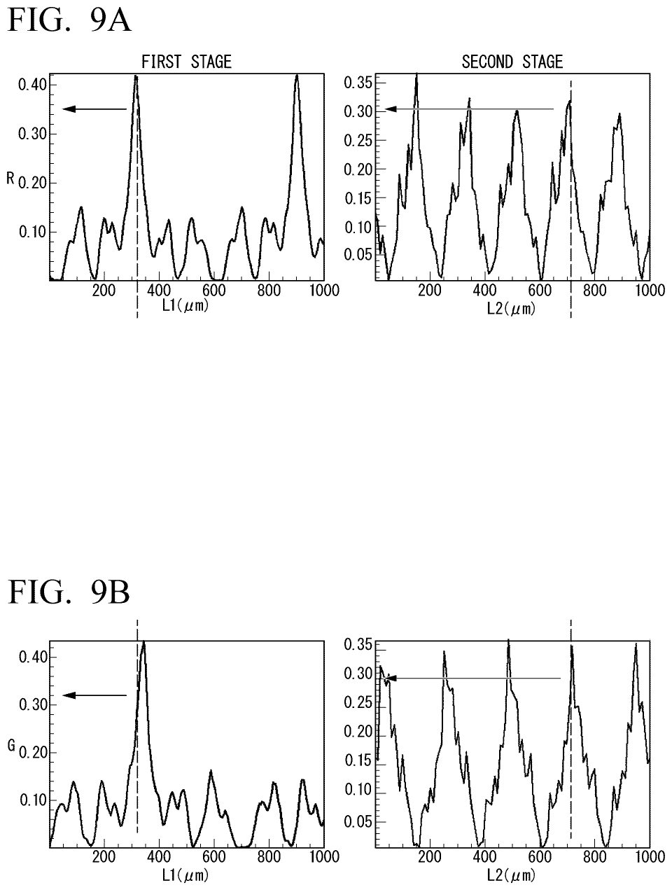

FIG. 9A and FIG. 9B are graphs showing the relationship between the length and the beat length of the first MMI type optical coupling main part and the second MMI type optical coupling main part, and the output intensity for red (R) and green (G) laser light beams. The horizontal axis represents the length (L1, L2) of the MMI type optical coupling element, and the vertical axis represents the light intensity.

The beat lengths of red (R) and green (G) are different. When the lengths of the first MMI type optical coupling main part and the second MMI type optical coupling main part are about 700 μm, both red (R) and green (G) can be coupled at an output intensity of 0.3.

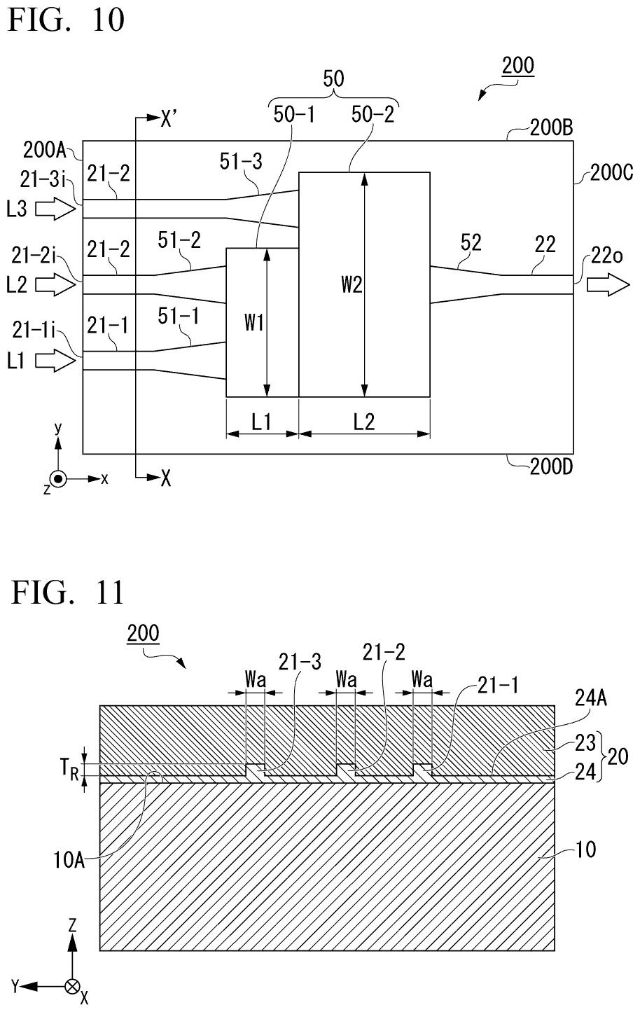

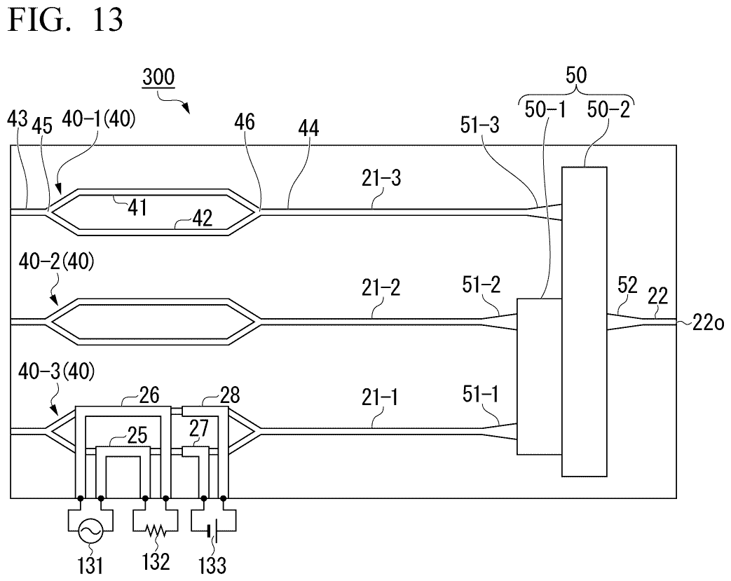

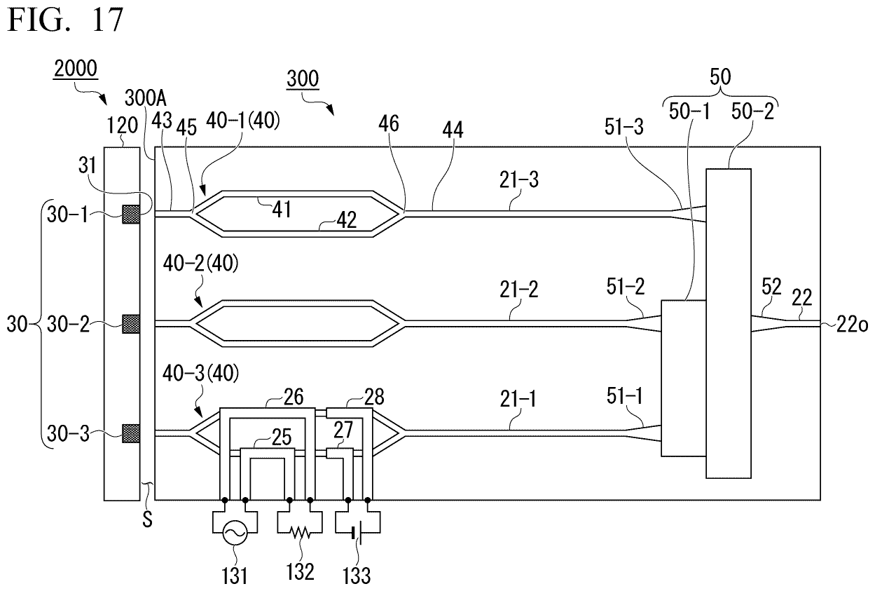

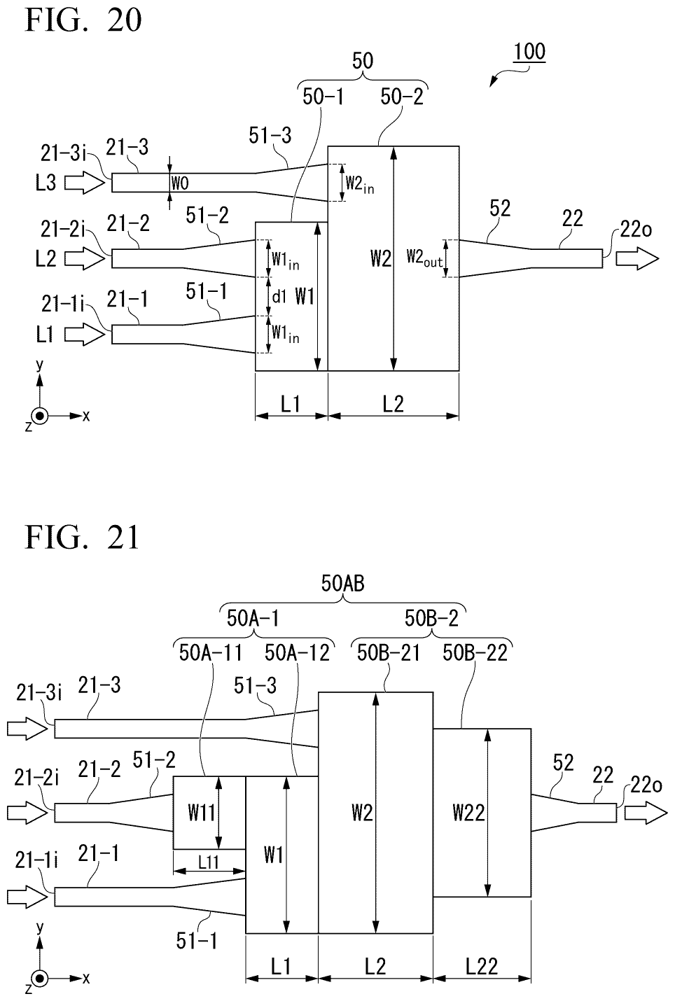

As the design concept of the MMI type optical coupler of the present disclosure, the interference position of a plurality of modes is determined by Formula (1), and the interference position is highly dependent on the wavelength and the width of the MMI type optical coupler. When the length of the MMI type optical coupler is designed so that L, is equal for red (R), green (G) and blue (B), it is possible to design respective colors of RGB with small losses, but the least common multiple of the wavelengths of respective colors is taken, and the length of the MMI type optical coupler becomes very long. Therefore, it is necessary to balance the loss of respective RGB colors and the length of the MMI type optical coupler, and when the MMI type optical coupler is designed to be short, the loss margin of respective colors with respect to the length of the MMI type optical coupler becomes narrow. As shown in FIG. 1, FIG. 2, FIG. 3, FIG. 4, FIG. 5, and FIG. 6 already described or FIG. 10, FIG. 13, FIG. 14, FIG. 17, FIG. 20, and FIG. 21 to be described below, when an MMI type optical coupler with different widths is provided at the input element, the side where it is not provided is not influenced at all, the length of light input from the side where it is provided at the interference position is corrected to improve the loss, and it is possible to reduce the loss by balancing the lengths for RGB.

### [Optical Coupling Member]

An optical coupling member according to the present disclosure includes a substrate made of a material different from lithium niobate and a lithium niobate film formed on the main surface of the substrate, and the optical coupler according to the above embodiment is formed on the lithium niobate film. Regarding components to be described below, components having the same functions as those in the above embodiment will be denoted with the same reference numerals and descriptions thereof will be omitted in some cases.

The lithium niobate film included in the optical coupling member according to the present disclosure may include an optical coupling element as shown in FIG. 1 to FIG. 6.

FIG. 10 is a schematic plan view of the optical coupling member according to the present disclosure.

In an optical coupling member 200 shown in FIG. 10, three light input ports 21-1i, 21-2i, and 21-2i are provided on a first side surface 200A, one light output port 22To is provided on a third side surface 200C at a position facing the first side surface 200A, and the light output port 22To is provided on a second side surface 200B or a fourth side surface 200D adjacent to the first side surface 200A.

FIG. 11 is a cross-sectional schematic diagram of the optical coupling member 200 shown in FIG. 10 cut along the YZ plane (X-X′ in FIG. 10).

The optical coupling member 200 shown in FIG. 11 includes a substrate 10 made of a material different from lithium niobate and a lithium niobate film 24 formed on the main surface of the substrate 10, and the optical coupler shown in FIG. 1 to FIG. 6 is formed in the lithium niobate film 24.

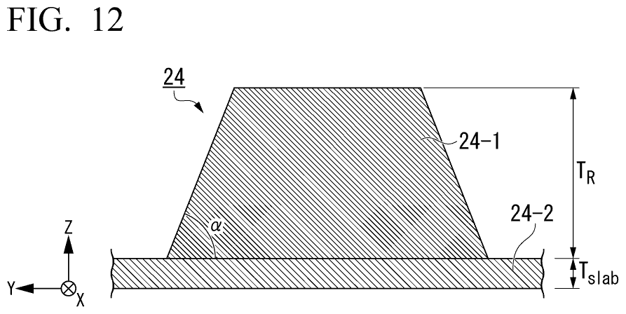

As shown in FIG. 12, the lithium niobate film 24 may be composed of a ridge 24-1 protruding from a first surface 24A and a slab layer 24-2 which is a part other than the ridge. The ridge constitutes the light input side optical waveguides 21-1, 21-2, and 21-3, the first MMI type optical coupling element 50-1, the second MMI type optical coupling element 50-2, and the light output side optical waveguide 22. The lithium niobate film 24 is covered with a buffer film 23. The lithium niobate film 24 and the buffer film 23 are collectively referred to as an optical coupling functional layer 20.

When the optical coupling member of the present embodiment is used in an eyeglasses-type image display device, the thickness (T_{slab}) of the slab layer 24-2 is preferably 0.1 to 0.3 μm.

When the optical coupling member of the present embodiment is used in an eyeglasses-type image display device, the thickness (T_{R}) of the ridge 24-1 is preferably 0.5 to 1.0 μm. This is because, if the thickness (T_{R}) of the ridge 24-1 is small, light does not propagate, and if the thickness is large, propagating light becomes multimode.

When the optical coupling member of the present embodiment is used in an eyeglasses-type image display device, the width (W_{R}) of the upper surface of the ridge is preferably 0.3 to 1.2 μm. This is because, if the width of the waveguide is small, light does not propagate, and if the width is large, propagating light becomes multimode.

When the optical coupling member of the present embodiment is used in an eyeglasses-type image display device, the lower interior angle (α) of the ridge 24-1 having a trapezoidal cross section is 65° or more. This is because, if the lower interior angle (inclination angle) is small, propagating light becomes multimode.

In the optical coupling member 200, when the difference in refractive index between the lithium niobate film and the buffer film is Δn, if the lithium niobate film is made of lithium niobate, Δn can be designed to be a larger value compared to when a material such as glass is used, the radius of curvature of the optical waveguide can be reduced, and furthermore, when a multimode interference type optical coupling element is used, compared to when a directional coupler is used, it is possible to prevent the coupling length from increasing, and it is possible to achieve both an improved degree of freedom in design and size reduction.

The substrate 10 may be, for example, a sapphire substrate, a Si substrate, or a thermally oxidized silicon substrate.

The substrate 10 is not particularly limited as long as it has a lower refractive index than a lithium niobate (LiNbO₃) film, and as a substrate on which a single crystal lithium niobate film can be formed as an epitaxial film, a sapphire single crystal substrate or a silicon single crystal substrate is preferable. The crystal orientation of the single crystal substrate is not particularly limited, and for example, since the c-axis oriented lithium niobate film has three-fold symmetry, it is desirable that the underlying single crystal substrate also have the same symmetry, and in the case of sapphire single crystal substrate, a c-plane substrate is preferable, and in the case of silicon single crystal substrate, a (111) plane substrate is preferable.

The lithium niobate film is, for example, a c-axis oriented lithium niobate film. The lithium niobate film is, for example, an epitaxial film epitaxially grown on the substrate 10. The epitaxial film is a single crystal film whose crystal orientation is aligned by the underlying substrate. The epitaxial film is a film having a single crystal orientation in the z direction and the xy in-plane direction, in which crystals are aligned and oriented in the x-axis, y-axis and z-axis directions. Whether the film formed on the substrate 10 is an epitaxial film can be determined by checking, for example, the peak intensity and the extreme point at the orientation position in 2θ-θ X-ray diffraction.

Specifically, when measurement is performed according to 2θ-θ X-ray diffraction, the peak intensities of all planes other than the target plane is 10% or less, preferably 5% or less of the maximum peak intensity of the target plane. For example, when the lithium niobate film is a c-axis oriented epitaxial film, the peak intensity of a plane other than the (00L) plane is 10% or less, preferably 5% or less of the maximum peak intensity of the (00L) plane. Here, (00L) is a general expression for equivalent planes such as (001) and (002).

In addition, in the above condition for checking the peak intensity at the orientation position, orientation in one direction is simply shown. Therefore, even if the above condition is satisfied, when the crystal orientation is not aligned within the plane, the X-ray intensity does not increase at a specific angle position, and no extreme point is observed. For example, when the lithium niobate film is made of lithium niobate, since LiNbO₃ has a trigonal crystal structure, there are three extreme points for LiNbO₃(014) in a single crystal. It is known that lithium niobate epitaxially grows in a so-called twin crystal state in which crystals rotated 180° around the c-axis are symmetrically coupled. In this case, since three extreme points are symmetrically coupled as two, the number of extreme points is 6. In addition, when a lithium niobate film is formed on a silicon single crystal substrate with the (100) plane, the substrate is four-fold symmetric, and 4×3=12 extreme points are observed. Here, in the present disclosure, a lithium niobate film epitaxially grown in a twin crystal state is also included in the epitaxial film.

The composition of lithium niobate is LiₓNbA_{y}O_{z}. A is an element other than Li, Nb, and O. x is 0.5 or more and 1.2 or less, and preferably 0.9 or more and 1.05 or less. y is 0 or more and 0.5 or less. z is 1.5 or more and 4.0 or less, and preferably 2.5 or more and 3.5 or less. The element A is, for example, K, Na, Rb, Cs, Be, Mg, Ca, Sr, Ba, Ti, Zr, Hf, V, Cr, Mo, W, Fe, Co, Ni, Zn, Sc, or Ce, and may be a combination of two or more of these elements.

In addition, the lithium niobate film may be a lithium niobate single crystal thin film bonded to a substrate.

[Optical Coupling Member with Optical Modulation Function]

An optical coupling member with an optical modulation function according to the present embodiment includes a substrate made of a material different from lithium niobate and a lithium niobate film formed on the main surface of the substrate, and in the lithium niobate film, the optical coupler according to the above embodiment and a Mach-Zehnder type optical modulator that is connected to the optical coupler and guides a plurality of visible light beams emitted from a plurality of visible laser light sources to the optical coupler are integrated. Regarding components to be described below, components having the same functions as those in the above embodiment will be denoted with the same reference numerals and descriptions thereof will be omitted in some cases.

The lithium niobate film included in the optical coupling member with an optical modulation function according to the present embodiment may include any of the optical couplers shown in FIG. 1 to FIG. 6.

FIG. 13 is a schematic plan view of the optical coupling member with an optical modulation function according to the present embodiment.

An optical coupling member 300 with an optical modulation function shown in FIG. 13 includes the substrate 10 made of a material different from lithium niobate (refer to FIG. 11) and the lithium niobate film 24 formed on the main surface of the substrate 10, and the optical coupler included in the optical coupling member 300 with an optical modulation function is formed in the lithium niobate film 24.

The optical coupling member 300 with an optical modulation function includes, for example, the 3×1 type optical coupler 100 according to the above embodiment (refer to FIG. 1) and a Mach-Zehnder type optical modulator 40.

As the Mach-Zehnder type optical modulator 40, a known Mach-Zehnder type optical modulator or optical waveguide can be used, and a light beam with a uniform wavelength and phase is split (decoupled) into two paired beams (pair), each of which is provided with a different phase, and the two beams are then merged (coupled). The intensity of the coupled light beam changes depending on the phase difference.

Each of Mach-Zehnder type optical waveguides 40-1, 40-2, and 40-3 shown in FIG. 13 includes a first optical waveguide 41, a second optical waveguide 42, an input path 43, an output path 44, a branching point 45 and a coupling point 46.

The output path 44 of the Mach-Zehnder type optical waveguide 40-1 is connected to the light input side optical waveguide 21-1 of the first MMI type optical coupling element 50-1. In addition, the output path 44 of the Mach-Zehnder type optical waveguide 40-2 is connected to the light input side optical waveguide 21-2 of the first MMI type optical coupling element 50-1. In addition, the output path 44 of the Mach-Zehnder type optical waveguide 40-3 is connected to the light input side optical waveguide 21-3 of the first MMI type optical coupling element 50-1.

The first optical waveguide 41 and the second optical waveguide 42 shown in FIG. 13 are configured to extend linearly in the x direction except for the vicinity of the branching point 45 and the vicinity of the coupling point 46, but the present invention is not limited to such a configuration. The first optical waveguide 41 and the second optical waveguide 42 shown in FIG. 13 have substantially the same length. The branching point 45 is located between the input path 43 and the first optical waveguide 41 and the second optical waveguide 42. The input path 43 is connected to the first optical waveguide 41 and the second optical waveguide 42 via the branching point 45. The coupling point 46 is located between the first optical waveguide 41 and the second optical waveguide 42 and the output path 44. The first optical waveguide 41 and the second optical waveguide 42 are connected to the output path 44 via the coupling point 46.

Electrodes 25 and 26 are electrodes for applying a modulation voltage to the Mach-Zehnder type optical waveguides 40-1, 40-2, and 40-3 (hereinafter simply referred to as “each Mach-Zehnder type optical waveguide 40”). The electrode 25 is an example of a first electrode, and the electrode 26 is an example of a second electrode. One end of the electrode 25 is connected to a power source 131, and the other end is connected to a terminating resistor 132. One end of the electrode 26 is connected to the power source 131, and the other end is connected to the terminating resistor 132. The power source 131 is a part of a drive circuit that applies a modulation voltage to each Mach-Zehnder type optical waveguide 40. For simplification of the drawings, in the electrodes 25 and 26, only the Mach-Zehnder type optical waveguide 40-3 is illustrated.

Electrodes 27 and 28 are electrodes that apply a DC bias voltage to each Mach-Zehnder type optical waveguide 40. One end of the electrode 27 and one end of the electrode 28 are connected to a power source 133. The power source 133 is a part of a DC bias application circuit that applies a DC bias voltage to each Mach-Zehnder type optical waveguide 40.

When a DC bias voltage is superimposed in the electrodes 25 and 26, the electrodes 27 and 28 do not need to be provided. In addition, ground electrodes may be provided around the electrodes 25, 26, 27, and 28.

### [Visible Light Source Module (First Embodiment)]

A visible light source module according to a first embodiment of the present disclosure includes the optical coupler according to the present disclosure, and a plurality of visible laser light sources that emit visible light beams that are coupled by an optical coupler.

FIG. 14 is a schematic plan view of the visible light source module according to the present disclosure.

A visible light source module 1000 shown in FIG. 14 includes the optical coupling member 200 including the MMI connected optical coupling unit 50 in which the first MMI type optical coupling element 50-1 and the second MMI type optical coupling element 50-2 are connected, and three visible laser light sources 30 (30-1, 30-2, 30-3) that emit visible light beams that are coupled by the optical coupling member 200. The optical coupling member 200 includes the substrate 10 made of a material different from lithium niobate (refer to FIG. 11) and the lithium niobate film 24 formed on the main surface of the substrate 10 (refer to FIG. 11), and has the first side surface 200A.

Regarding components shown in FIG. 14, components having the same functions as those described above are denoted with the same reference numerals and descriptions thereof may be omitted.

As a visible laser light source 30, various laser elements can be used. For example, commercially available laser diodes (LD) for red light, green light, and blue light can be used. For red light, light with a peak wavelength of 610 nm or more and 750 nm or less can be used. For green light, light with a peak wavelength of 500 nm or more and 560 nm or less can be used. For blue light, light with a peak wavelength of 435 nm or more and 480 nm or less can be used.

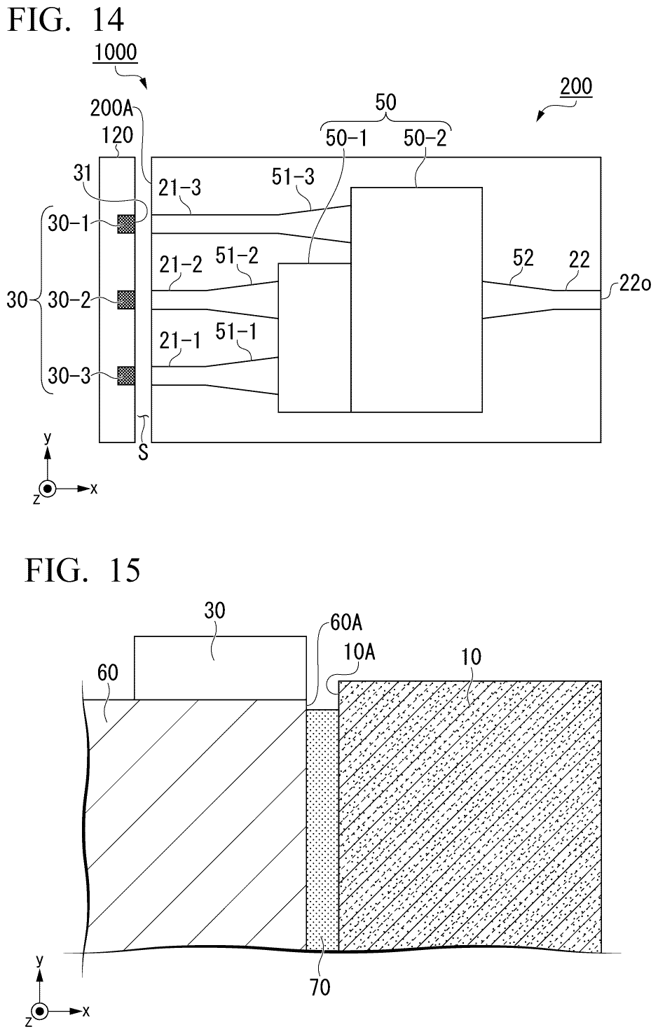

In the visible light source module 1000, the visible laser light sources 30-1, 30-2, and 30-3 are respectively an LD that emits green light, an LD that emits blue light, and an LD that emits red light. The visible laser light sources 30-1, 30-2, and 30-3 are disposed at intervals in a direction substantially perpendicular to the emission direction of light beams emitted from respective LDs, and are provided on the upper surface of a light source base 60 (refer to FIG. 15).

In the visible light source module 1000, an example in which there are two or three visible laser light sources is shown, but the number is not limited to two or three, and may be four or more as long as there are a plurality of visible laser light sources. The plurality of visible laser light sources may emit light beams with wavelengths different from each other or some visible laser light sources may emit light beams with the same wavelength. In addition, light other than red (R), green (G), and blue (B) can be used as light to be emitted, and the mounting order of red (R), green (G), and blue (B) described using the drawings does not necessarily have to be this order and can be appropriately changed.

FIG. 15 is a cross-sectional schematic diagram of a part of the light source module 1000 shown in FIG. 14 cut along the XZ plane. Only a part of the vicinity of the bonding part is illustrated.

The light source 30 is installed on the upper surface of the light source base 60. The light source base 60 may be common to all light sources or may be provided individually for each light source.

The light source base 60 is made of, for example, aluminum nitride (AlN), aluminum oxide (Al₂O₃), or silicon (Si).

The light source base 60 and the optical waveguide substrate 10 on which the optical coupling functional layer 20 is formed can be directly bonded via a metal layer 70. With this configuration, further size reduction can be achieved by eliminating spatial coupling or fiber coupling.

When a bonding surface 60A of the light source base 60 and a bonding surface 10A of the optical waveguide substrate 10 are bonded via the metal layer 70, the relative positions of the light source base 60 and the optical waveguide substrate 10 can be adjusted during production to align the optical axis positions of laser light beams so that the optical axes of the light sources 30 match the axes of the input waveguides (active alignment).

The metal layer 70 may be composed of a plurality of metal layers.

When the light source module of the present embodiment is used in XR glasses, in consideration of the amount of light required in the XR glasses, the gap (interval) S (refer to FIG. 14) between the bonding surface 60A of the light source base 60 and the bonding surface 10A of the optical waveguide substrate 10 is preferably, for example, more than 0 μm and 5 μm or less.

### (Driving Method)

The optical modulator can modulate input light into output light using a high-frequency modulation voltage and a DC bias voltage. The operating point Vd of the optical modulator is adjusted by controlling the DC bias voltage Vdc. The operating point Vd is the voltage at the center of the modulation voltage amplitude Vpp. The half-wavelength voltage of the high-frequency modulation voltage is Vπ(RF).

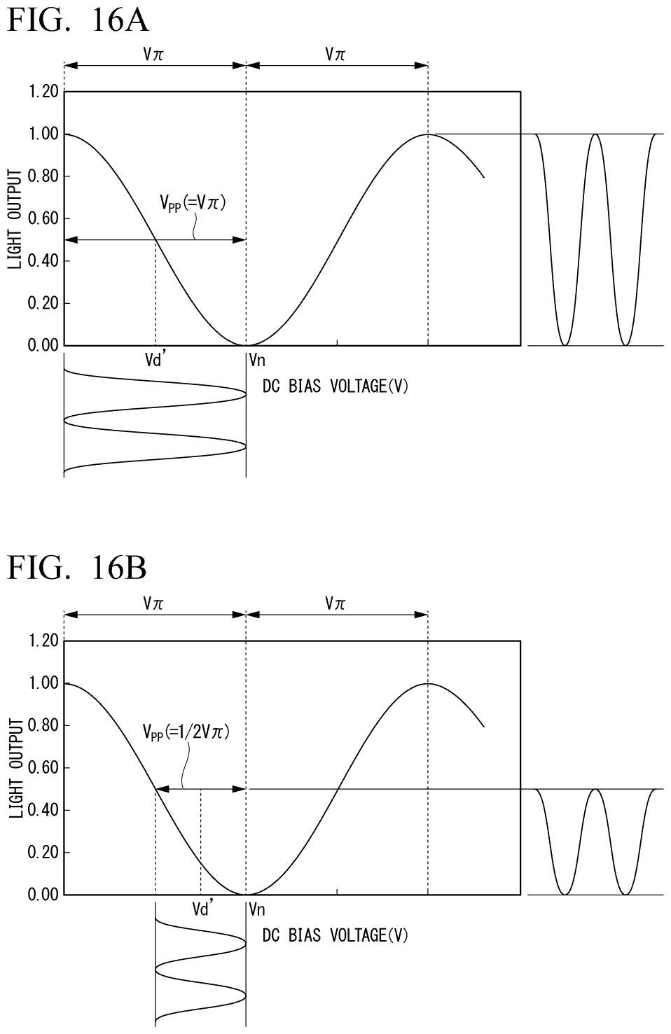

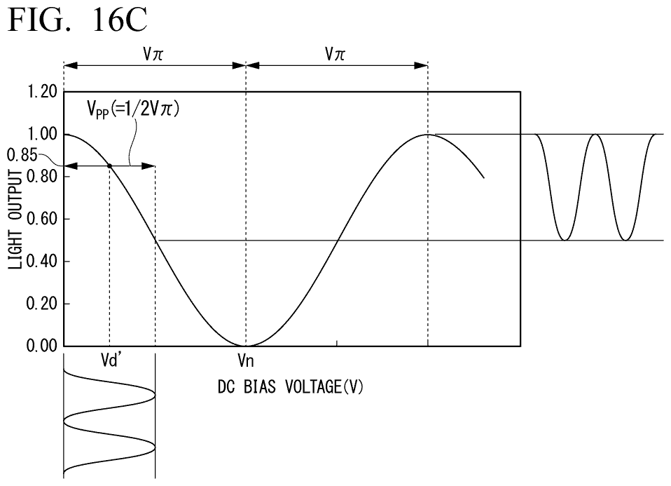

FIG. 16A to FIG. 16C are diagrams for explaining three examples of an optical modulator driving method.

In FIG. 16A to FIG. 16C, the horizontal axis represents the DC bias voltage applied to the optical modulator, and the vertical axis represents the intensity of light output at the applied voltage. The applied voltage width Vpp is the difference between the minimum value (Vmin) and the maximum value (Vmax) of the applied voltage.

FIG. 16A shows an example in which the operating point Vd′ is set so that the shift amount of the operating point voltage is (Vn−0.5Vπ), and thus the DC bias voltage can be set to approximately 0 V. For example, when the applied voltage width Vpp of the modulation voltage Vm is a half-wavelength voltage Vπ(RF), a modulation voltage Vm in the range of (−½)Vπ(RF) to (½)Vπ(RF) is applied to the optical modulator. As shown in FIG. 16A, the light output from the optical modulator is maximum when the modulation voltage Vm is (−½)Vπ(RF), and minimum when the modulation voltage Vm is (½)Vπ(RF), and the light output when the modulation voltage Vm is 0 V is 50% of the maximum output.

Similarly, with reference to FIG. 16B, optical modulation of an optical modulator in which the operating point Vd′ is set so that the shift amount of the operating point voltage is (Vn−0.25Vπ), and the applied voltage width Vpp of the modulation voltage Vm is controlled to be (¼) wavelength voltage (½)Vπ(RF) will be described.

In this case, if the shift amount of the operating point voltage is set to (Vn−0.25Vπ), the operating point Vd′ can be set to a DC bias voltage of approximately 0 (V). A modulation voltage Vm corresponding to a range of (−¼)Vπ(RF) to (¼) Vπ (RF) is applied to the optical modulator. As shown in FIG. 16B, the light output from the optical modulator is maximum when the modulation voltage Vm is (−¼)Vπ(RF) and minimum when the modulation voltage Vm is (¼)Vπ(RF), and the light output when the modulation voltage Vm is 0 V(Vd′) is 15% of the maximum output.

Similarly, with reference to FIG. 16C, optical modulation of an optical modulator in which the operating point Vd′ is set so that the shift amount of the operating point voltage is (Vn−0.75Vπ), and the applied voltage width Vpp of the modulation voltage Vm is controlled to be (¼) wavelength voltage (½) Vπ(RF) will be described.

In this case, if the shift amount of the operating point voltage is set to (Vn−0.75Vπ), the operating point Vd′ can be set to a DC bias voltage of approximately 0 (V). A modulation voltage Vm corresponding to a range of (−¼)Vπ(RF) to (¼)Vπ(RF) is applied to the optical modulator. As shown in FIG. 16C, the light output from the optical modulator is maximum when the modulation voltage Vm is (−¼)Vπ(RF) and minimum when the modulation voltage Vm is (¼)Vπ(RF), and the light output when the modulation voltage Vm is 0 V(Vd′) is 85% of the maximum output.

### [Visible Light Source Module (Second Embodiment)]

FIG. 17 is a schematic plan view of a visible light source module according to a second embodiment of the present disclosure.

A visible light source module 2000 shown in FIG. 17 includes the optical coupling member 300 with an optical modulation function shown in FIG. 13 and the plurality of visible laser light sources 30 (30-1, 30-2, 30-3) that emit visible light beams that are coupled by the optical coupling member 300 with an optical modulation function. The optical coupling member 300 with an optical modulation function includes the substrate 10 made of a material different from lithium niobate (refer to FIG. 11) and the lithium niobate film 24 formed on the main surface of the substrate 10 (refer to FIG. 11), and has a side surface 300A.

Regarding components shown in FIG. 17, components having the same functions as those described above are denoted with the same reference numerals and descriptions thereof can be omitted.

The visible light source module 2000 includes the visible laser light sources 30-1, 30-2, and 30-3 and the same number of (three) Mach-Zehnder type optical waveguides 40-1, 40-2, and 40-3. The visible laser light sources 30-1, 30-2, and 30-3 and the Mach-Zehnder type optical waveguides 40-1, 40-2, and 40-3 are positioned so that light beams emitted from the visible laser light sources enter corresponding Mach-Zehnder type optical waveguides.

The light source base 60 on which the visible laser light sources 30-1, 30-2, and 30-3 are mounted and the substrate 10 on which the optical coupling functional layer 20 having the optical coupling member 300 with an optical modulation function is formed can be directly bonded via a metal bonding layer. With this configuration, further size reduction can be achieved by eliminating spatial coupling or fiber coupling.

In addition, the relative positions of the light source base 60 and the substrate 10 can be adjusted during production to align the optical axis positions of laser light beams so that the optical axes of the visible light lasers match the axes of the input paths 43 of the Mach-Zehnder type optical waveguides 40-1, 40-2, and 40-3 (active alignment).

The size of the optical coupling functional layer 20 is, for example, 100 mm² or less. If the size of the optical coupling functional layer 20 is 100 mm² or less, it is suitable for XR glasses such as AR glasses and VR glasses.

The optical coupling functional layer 20 can be produced by a known method. For example, the optical coupling functional layer 20 is produced using semiconductor processes such as epitaxial growth, photolithography, etching, vapor phase growth and metallization.

When the visible light source module according to the present invention is applied to XR glasses such as AR glasses and VR glasses, the widths of the first MMI type optical coupling element and the second MMI type optical coupling element constituting the optical coupler are, for example, preferably about 5 to 15 μm, and the lengths thereof are, for example, preferably about 100 to 1,000 μm.

For example, in a retina projection type display, in order to display an image in a desired color, it is necessary to independently and quickly modulate the intensities of three RGB colors that express visible light. If such modulation is performed only by the visible laser light source (current modulation), the load on the IC that controls the modulation increases, but it is also possible to use modulation (voltage modulation) by the Mach-Zehnder type optical modulator 40 (the optical coupling member 300 with an optical modulation function) in combination. In this case, coarse adjustment may be performed with the current (visible laser light source) and fine adjustment may be performed with the voltage (the Mach-Zehnder type optical modulator 40) or coarse adjustment may be performed with the voltage (the Mach-Zehnder type optical modulator 40), and fine adjustment may be performed with the current (visible laser light source). Since fine adjustment with the voltage provides better responsiveness, the former is preferably used when responsiveness is important, and since fine adjustment with the current requires a lower current, which reduces power consumption, the latter is preferably used when reducing power consumption is important.

### [Optical Engine and XR Glasses]

In this specification, the optical engine is a device including a plurality of light sources, an optical system including a coupling element that combines a plurality of light beams emitted from the plurality of light sources into one light beam, an optical scanning mirror that reflects light emitted from the optical system at different angles so that an image is displayed, and a control element that controls the optical scanning mirror.

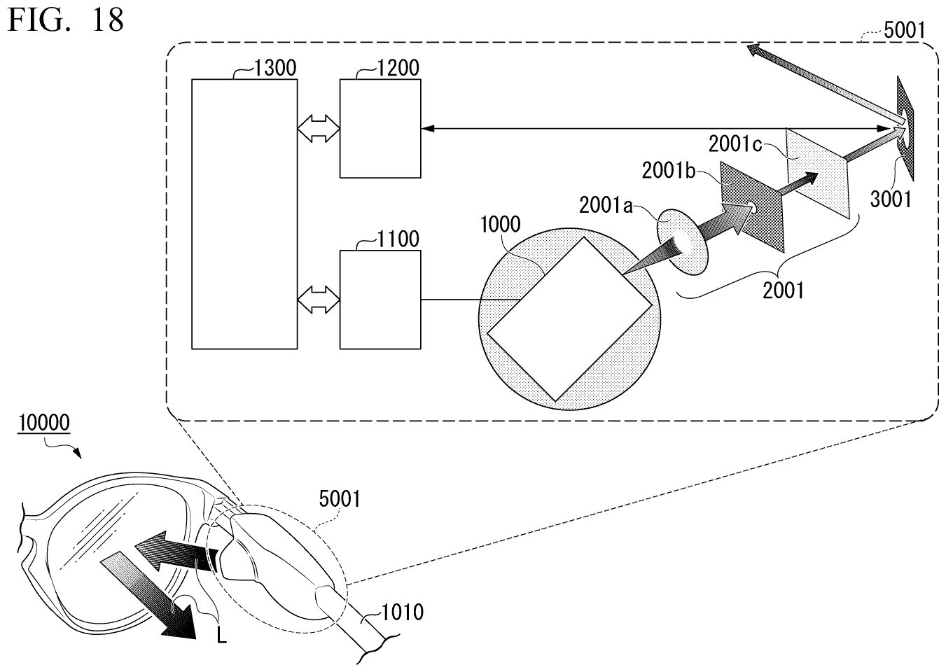

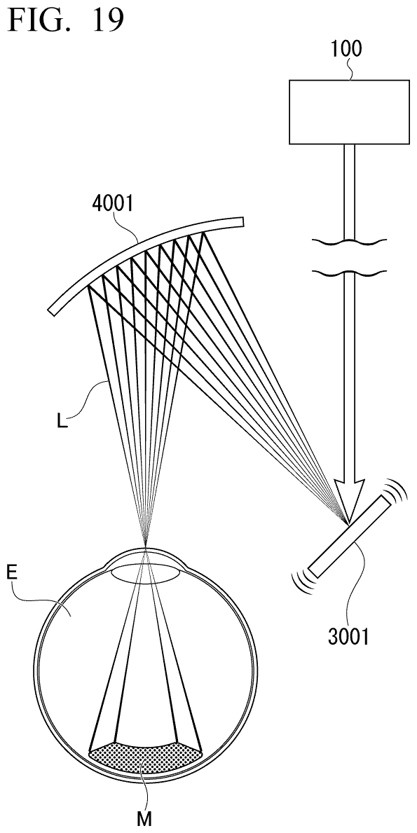

FIG. 18 is a conceptual diagram for explaining an example of XR glasses of the present invention. FIG. 19 is a conceptual diagram showing a state in which an image is directly projected onto the retina with laser light beams emitted from the light source module in XR glasses shown in FIG. 18. The reference numeral L is image display light.

XR glasses (eyeglasses) 10000 of the present embodiment are glasses-type terminals. XR is a general term for virtual reality (VR), augmented reality (AR), and mixed reality. The reference numeral L shown in FIG. 19 is image display light.

The XR glasses 10000 of the present embodiment shown in FIG. 18 includes the light source module 1000 according to the above embodiment mounted in an optical engine 5001 installed on a frame 1010.

As shown in FIG. 18, the optical engine 5001 includes the light source module 1000, an optical scanning mirror 3001, an optical system 2001 that connects the light source module 1000 and the optical scanning mirror 3001, a laser driver 1100, an optical scanning mirror driver 1200, and a video controller 1300 that controls these drivers.

As the optical scanning mirror 3001, for example, a MEMS mirror can be used. In order to project a 2D image, it is preferable to use, as the optical scanning mirror 3001, a two-axis MEMS mirror that vibrates to reflect laser light at different angles in the horizontal direction (X direction) and the vertical direction (Y direction).

The optical system 2001 optically processes laser light emitted from the light source module 1000. As the optical system 2001, for example, one having a collimator lens 2001a, a slit 2001b, and an ND filter 2001c can be used. The optical system 2001 shown in FIG. 18 is an example, and other configurations may be used.

In the XR glasses 10000 of the present embodiment shown in FIG. 18, as shown in FIG. 19, laser light R emitted from the light source module 1000 attached to the frame 1010 is reflected by the optical scanning mirror 3001, and additionally reflected by a lens 4001 of the XR glasses 10000, and enters a user's eyeball E as image display light L so that an image (video) can be directly projected onto the retina M.

In the XR glasses 10000 of the present embodiment, since the light source module 1000 of the present embodiment is mounted, the electric field efficiency is reduced.

The embodiments of the present invention have been described in detail above with reference to the drawings, but configurations and combinations thereof in the embodiments are only examples, and additions, omissions, substitutions and other modifications of the configurations can be made without departing from the spirit and scope of the present invention.

### EXAMPLES

Hereinafter, the present invention will be described in more detail with reference to examples. However, the present invention is not limited to the following examples.

### <3-Input and 1-Output Type MMI Connected Optical Coupling Unit (One-Stage Shift)>

Regarding a comparative example model of the 3-input and 1-output type MMI connected optical coupling unit which was the same as the example model corresponding to the 3-input and 1-output type MMI connected optical coupling unit shown in FIG. 1 except that no first MMI type optical coupling unit was provided as an MMI type optical coupling incidence position shift element, a simulation was performed to compare the coupling losses of light beams with three RGB colors (losses in light intensities from when light beams are input until the light beams are output after passing through the MMI connected optical coupling unit). Fimmwave (commercially available from Photon Design) was used as simulation software.

### Example 1

The sizes of an example model of a 3-input and 1-output type MMI connected optical coupling unit shown in FIG. 20 were as follows. The first MMI type optical coupling element 50-1 was described as an MMI type optical coupling incidence position shift element, and the second MMI type optical coupling element 50-2 was described as an MMI type optical coupling main part.

### (Lengths and Widths of Components)

The length L1 of the MMI type optical coupling incidence position shift element: 60 μm
The width W1 of the MMI type optical coupling incidence position shift element: 8 μm
The length L2 of the MMI type optical coupling main part: 2,600 μm
The width W2 of the MMI type optical coupling main part: 13 μm
The maximum widths W1ᵢₙ and W2ᵢₙ of the light input side tapered part: 2 μm
The maximum width W2ₒᵤₜ of the light output side tapered part: 2 μm
The lengths of the light input side tapered part and the light output side tapered part: 50 μm (common)
The width W0 of the optical waveguide except for the tapered part: 0.8 μm (common)
The maximum width of the light input side tapered part and the maximum width of the light output side tapered part are the widths of parts where the tapered part is connected to the optical coupling element.

### (Wavelength of Laser Light Propagating Through Light Input Side Optical Waveguide)

The wavelength of L1: 637 μm (red R)
The wavelength of L2: 455 μm (blue B)
The wavelength of L3: 520 μm (green G)

### (Distance Between Adjacent Light Input Side Optical Waveguides)

The distance d1 between the upper surfaces of adjacent tapered parts: 1.5 μm

Here, as shown in the drawing, the distance d1 between the upper surfaces is the distance between the upper surfaces of parts of adjacent tapered parts connected to the first MMI type optical coupling element 50-1.

### Comparative Example 1

A model of an MMI connected optical coupling unit according to Comparative Example 1 was the same model as and had the same parameters as that of Example 1 except that an MMI type optical coupling unit corresponding to the MMI connected optical coupling unit 50 of Example 1 was an MMI connected optical coupling unit including no first MMI type optical coupling element as an MMI type optical coupling incidence position shift element.

The coupling losses (losses in light intensities from when light beams are input until the light beams are output after passing through the MMI connected optical coupling unit) of light beams with three RGB colors of Example 1 and Comparative Example 1 were as follows.

The coupling losses in Example 1 were 5 dB, 4 dB, and 4 dB for R, G, and B, respectively.

The coupling losses in Comparative Example 1 were 12 dB, 4 dB, and 2 dB for R, G, and B, respectively.

The coupling loss for green G remained unchanged, but the coupling loss for blue B in Example 1 was slightly worse than in Comparative Example 1, and the coupling loss for red R in Example 1 was significantly improved compared to Comparative Example 1.

### <3-Input and 1-Output Type MMI Connected Optical Coupling Unit (One-Stage Shift, Different RGB Arrangement)>

### Example 2

Example 2 had the same model and same parameters as Example 1 except that the length L1 of the first MMI type optical coupling element and the length L2 of the second MMI type optical coupling element were as follows, and arrangement of incidence disposition of three RGB colors was different.

### (Lengths of Components)

The length L1 of the MMI type optical coupling incidence position shift element: 50 μm
The length L2 of the MMI type optical coupling main part: 300 μm

### (RGB Incidence Disposition and Wavelength of Laser Light Propagating Through Light Input Side Optical Waveguide)

The wavelength of L1: 520 μm (green G)
The wavelength of L2: 455 μm (blue B)
The wavelength of L3: 637 μm (red R)

### Comparative Example 2

Comparative Example 2 had the same model and same parameters as Example 2 except that an MMI connected optical coupling unit including no first MMI type optical coupling element was used.

The coupling losses of light beams with three RGB colors of Example 2 and Comparative Example 3 were as follows.

The coupling losses in Example 2 were 4 dB, 5 dB, and 6 dB for R, G, and B, respectively.

The coupling losses in Comparative Example 2 were 4 dB, 13 dB, 6 dB for R, G, and B, respectively.

The coupling losses for red R and blue B remained unchanged, but the coupling loss for green G in Example 2 was significantly improved compared to Comparative Example 2.

### <3-Input and 1-Output Type MMI Connected Optical Coupling Unit (Two-Stage Shift)>

Regarding a comparative example model, which was the same example model corresponding to the 3-input and 1-output type MMI connected optical coupling unit including the MMI connected optical coupling units shown in FIG. 3 and FIG. 4 in combination except that no first MMI type optical coupling element was provided as an MMI type optical coupling incidence position shift element, a simulation was performed to compare the coupling losses of light beams with three RGB colors (losses in light intensities from when light beams are input until the light beams are output after passing through the MMI connected optical coupling unit).

### Example 3

The sizes of the example model of the 3-input and 1-output type MMI connected optical coupling unit shown in FIG. 21 were as follows. The width of the light input side tapered part, the width of the light output side tapered part, the width of the optical waveguide except for the tapered part, and the distance between the upper surface of adjacent tapered parts were the same as the sizes of the example model shown in FIG. 20.

### (Lengths and Widths of Components)

The length L11 of the first MMI type optical coupling incidence position shift element: 40 μm
The width W11 of the first MMI type optical coupling incidence position shift element: 3 μm
The length L1 of the second MMI type optical coupling incidence position shift element: 25 μm
The width W1 of the second MMI type optical coupling incidence position shift element: 8 μm
The length L2 of the first MMI type optical coupling main part: 320 μm
The width W2 of the first MMI type optical coupling main part: 13 μm
The length L22 of the second MMI type optical coupling main part: 685 μm
The width W22 of the second MMI type optical coupling main part: 7 μm

### (Wavelength of Laser Light Propagating Through Light Input Side Optical Waveguide)

The wavelength of L1: 637 μm (red R)
The wavelength of L2: 455 μm (blue B)
The wavelength of L3: 520 μm (green G)

### Comparative Example 3

A comparative example model of a 3-input and 1-output type MMI connected optical coupling unit according to Comparative Example 3 was the same model as and had the same parameters as that of Example 3 except that an MMI connected optical coupling unit not including a first MMI type optical coupling incidence position shift element or a second MMI type optical coupling incidence position shift element was used.

The coupling losses (losses in light intensities from when light beams are input until the light beams are output after passing through the MMI connected optical coupling unit) of light beams with three RGB colors of Example 3 and Comparative Example 3 were as follows.

The coupling losses in Example 3 were 3.7 dB, 3.7 dB, and 3.7 dB for R, G, and B, respectively.

The coupling losses in Comparative Example 3 were 3.7 dB, 6.2 dB, and 6.2 dB for R, G, and B, respectively.

The coupling loss for red R remained unchanged, but the coupling losses for blue B and green G in Example 3 were significantly improved compared to Comparative Example 3.

### Examples 4 to 12

In Examples 4 to 6, the lengths and widths of the first MMI type optical coupling main part and the second MMI type optical coupling main part were the same as those of Example 3, but the lengths and widths of the first MMI type optical coupling incidence position shift element and the second MMI type optical coupling incidence position shift element were changed from those of Example 3.

The length L1 of the second MMI type optical coupling incidence position shift element in Examples 4 to 6 was respectively 2 μm, 15 μm, and 65 μm.

In Example 7, the length L1 of the second MMI type optical coupling incidence position shift element and the length L11 of the first MMI type optical coupling incidence position shift element were 30 μm and 40 μm, respectively.

In Example 8, the length L1 of the second MMI type optical coupling incidence position shift element and the length L11 of the first MMI type optical coupling incidence position shift element were 7 μm and 55 μm, respectively.

In Example 9, the length L1 of the second MMI type optical coupling incidence position shift element and the length L11 of the first MMI type optical coupling incidence position shift element were 7 μm and 55 μm, respectively, and additionally, W11 of the first MMI type optical coupling incidence position shift element was 3.4 μm.

In Example 10, the length L1 of the second MMI type optical coupling incidence position shift element and the length L11 of the first MMI type optical coupling incidence position shift element were 7 am and 55 μm, respectively, and additionally, W11 of the first MMI type optical coupling incidence position shift element was 2.7 μm.

In Example 11, the length L1 of the second MMI type optical coupling incidence position shift element and the length L11 of the first MMI type optical coupling incidence position shift element were 7 μm and 55 μm, respectively, and additionally, the width W1 of the second MMI type optical coupling incidence position shift element and W11 of the first MMI type optical coupling incidence position shift element were 5.6 μm and 3.4 μm, respectively.

In Example 12, the length L1 of the second MMI type optical coupling incidence position shift element and the length L11 of the first MMI type optical coupling incidence position shift element were 7 μm and 55 μm, respectively, and additionally, the width W1 of the second MMI type optical coupling incidence position shift element and W11 of the first MMI type optical coupling incidence position shift element were 4.7 μm and 2.7 μm, respectively.

Table 1 shows the sizes and the RGB coupling losses of Examples 3 to 12, and Comparative Example 3. In Table 1, the first MMI type optical coupling incidence position shift element is abbreviated as a first shift element, the second MMI type optical coupling incidence position shift element is abbreviated as a second shift element, the first MMI type optical coupling main part is abbreviated as a first main part, and the second MMI type optical coupling main part is abbreviated as a second shift element.

TABLE 1

| | First shift | | Second shift | | First | | Second | | | | |
|---|---|---|---|---|---|---|---|---|---|---|---|
| | element | | element | | main part | | main part | | Coupling loss | | |
| | L11 | W11 | L1 | W1 | L2 | W2 | L22 | W22 | R | G | B |
| Example 3 | 40 | 3 | 25 | 8 | 320 | 13 | 685 | 7 | 3.7 | 3.7 | 3.7 |
| Example 4 | 2 | 3 | 25 | 8 | 320 | 13 | 685 | 7 | 3.7 | 3.7 | 4.3 |
| Example 5 | 15 | 3 | 25 | 8 | 320 | 13 | 685 | 7 | 3.7 | 3.7 | 3.7 |
| Example 6 | 65 | 3 | 25 | 8 | 320 | 13 | 685 | 7 | 3.7 | 3.7 | 3.7 |
| Example 7 | 40 | 3 | 30 | 8 | 320 | 13 | 685 | 7 | 3.7 | 3.8 | 3.8 |
| Example 8 | 55 | 3 | 7 | 8 | 320 | 13 | 685 | 7 | 3.7 | 4.9 | 4.0 |
| Example 9 | 55 | 3.4 | 7 | 8 | 320 | 13 | 685 | 7 | 3.7 | 4.9 | 5.0 |
| Example 10 | 55 | 2.7 | 7 | 8 | 320 | 13 | 685 | 7 | 3.7 | 4.9 | 5.0 |
| Example 11 | 55 | 3.4 | 7 | 5.6 | 320 | 13 | 685 | 7 | 3.7 | 5.0 | 5.0 |
| Example 12 | 55 | 2.7 | 7 | 4.7 | 320 | 13 | 685 | 7 | 3.7 | 5.0 | 5.0 |
| Comparative | 0 | 0 | 0 | 0 | 320 | 13 | 685 | 7 | 3.7 | 6.2 | 6.2 |
| Example 3 | | | | | | | | | | | |

In all of Examples 3 to 12, the coupling loss for red R remained unchanged, but the light intensity coupling losses for blue B and green G were significantly improved compared to Comparative Example 3.

It can be understood that the lengths and widths of the first MMI type optical coupling incidence position shift element and the second MMI type optical coupling incidence position shift element can be appropriately selected in order to reduce light intensity coupling losses for three RGB colors.

In Example 4, L11 was 2 μm, but the coupling loss for green G had the same improvement as in Example 3 in which L11 was 40 μm, and the coupling loss for blue B had a slight degree of improvement compared to Example 3. It was found that the coupling loss was improved when the length L11 of the first MMI type optical coupling incidence position shift element was 2 μm or more.

In Examples 5 and 6, L11 was changed to 15 μm and 65 μm, respectively, compared to Example 3 (L11=40 μm), and the coupling losses for all RGB were improved to the same extent as in Example 3.

In Example 7, L1 was changed to 30 μm compared to Example 3 (L1=25 μm), the coupling loss for red R was improved to the same extent as in Example 3, and the coupling losses for GB were also improved to the approximately the same extent as in Example 3.

In Example 8, L11 was changed to 55 μm and L1 was changed to 7 μm compared to Example 3 (L11=40, L1=25 μm), the coupling loss for red R was improved to the same extent as in Example 3, the coupling loss for blue B was also improved to the approximately the same extent as in Example 3, and regarding green G, a lower coupling loss improvement effect was obtained compared to RB, but a larger coupling loss improvement effect was obtained compared to Comparative Example 3.

In Examples 9 and 10, W11 was changed to 3.4 μm and 2.7 μm, respectively, compared to Example 8 (W11=3 μm), but the coupling loss for red R was improved to the same extent as in Example 8 (the same extent as in Example 3), the coupling loss for green G was improved to the same extent as in Example 8, and regarding blue B, a lower coupling loss improvement effect was obtained compared to RG, but a larger coupling loss improvement effect was obtained compared to Comparative Example 3.

In Example 11, W1 was changed to 5.6 μm compared to Example 9 (W1=8 μm), but the coupling loss for red R was improved to the same extent as in Example 9 (the same extent as in Example 3), the coupling loss for green G was also improved to approximately the same extent as in Example 9, and the coupling loss for blue B was also improved to the same extent as in Example 9.

In Example 12, W1 was changed to 4.7 μm compared to Example 10 (W1=8 μm), but the coupling loss for red R was improved to the same extent as in Example 10 (the same extent as in Example 3), the coupling loss for green G was also improved to approximately the same extent as in Example 9, and the coupling loss for blue B was also improved to the same extent as in Example 9.

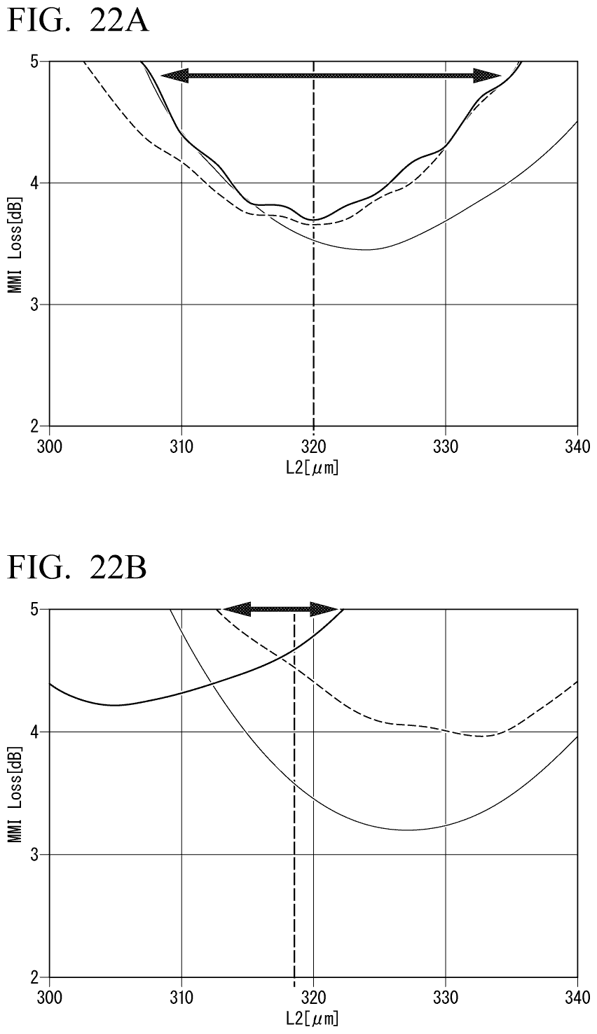

FIG. 22A is a graph with a horizontal axis that represents the length L2 of the first MMI type optical coupling main part and a vertical axis that represents the loss in light intensity after light beams for each RGB wavelength passed through the MMI connected optical coupling unit for a model which had same structure as the example model (model of Example 3) of the MMI connected optical coupling unit shown in FIG. 21, and in which only the lengths L11 and L1 of the first MMI type optical coupling incidence position shift element and the second MMI type optical coupling incidence position shift element were different.

The lengths L11 and L1 of the first MMI type optical coupling incidence position shift element and the second MMI type optical coupling incidence position shift element were as follows.
The length L11 of the first MMI type optical coupling incidence position shift element: 44 μm
The length L1 of the second MMI type optical coupling incidence position shift element: 27 μm

FIG. 22B is a graph similar to FIG. 22A for a model of the MMI connected optical coupling unit of Comparative Example 3 (MMI connected optical coupling unit not including a first MMI type optical coupling incidence position shift element or a second MMI type optical coupling incidence position shift element).

Comparing FIG. 22A and FIG. 22B, it can be understood that the deviation of the RGB coupling loss margin of the example including the MMI type optical coupling incidence position shift element was significantly improved compared to the comparative example including no MMI type optical coupling incidence position shift element.

In the example of FIG. 22A, the minimum values of the light intensity losses for respective RGB colors were in the range of 320±12 μm, but in the comparative example of FIG. 22B, the minimum values of the light intensity losses for respective colors were 318±3 μm, and thus L1 could be appropriately selected in order to reduce the light intensity losses for three RGB colors.

### (Effect of Tapered Part)

### Example 13

Example 13 showed a model which had the same structure as the example model (model of Example 3) of the MMI connected optical coupling unit shown in FIG. 21 and in which only the lengths L11 and L1 of the first MMI type optical coupling incidence position shift element and the second MMI type optical coupling incidence position shift element, and the width W1 of the second MMI type optical coupling incidence position shift element were different, and which had no light input side tapered part and light output side tapered part. The structure having no light input side tapered part or light output side tapered part is a structure in which all optical waveguides are connected to the MMI connected optical coupling unit while maintaining the same thickness (straight).

The lengths L11 and L1 of the first MMI type optical coupling incidence position shift element and the second MMI type optical coupling incidence position shift element, and the width W1 of the second MMI type optical coupling incidence position shift element were as follows.
The length L11 of the first MMI type optical coupling incidence position shift element: 44 μm
The length L1 of the second MMI type optical coupling incidence position shift element: 27 μm
The width W1 of the second MMI type optical coupling incidence position shift element: 5 μm

### Comparative Example 4

A model of Comparative Example 4 was the same model as and had the same parameters as that of Example 13 except that an MMI connected optical coupling unit not including a first MMI type optical coupling incidence position shift element or a second MMI type optical coupling incidence position shift element was used.

The coupling losses of light beams with three RGB colors of Example 13 and Comparative Example 4 were as follows.

The coupling losses in Example 13 were 6 dB, 6 dB, and 4 dB for R, G, and B, respectively.

The coupling losses in Comparative Example 4 were 6 dB, 9 dB, and 7 dB for R, G, and B, respectively.

The coupling loss for red R was not changed compared to Comparative Example 4, but both the coupling losses for blue B and green G were improved by 3 dB compared to Comparative Example 4.

As described above, it was confirmed that, even in a configuration having no tapered part, the effect of the MMI type optical coupling incidence position shift element could be obtained.

### (MMI Connected Optical Coupling Unit)

### Example 14

Example 14 had the structure of the example model of the MMI connected optical coupling unit shown in FIG. 6, and the size parameters were as follows.
The length L10 of the first MMI type optical coupling element 150-1: 145 μm
The width W10 of the first MMI type optical coupling element 150-1: 2.3 μm
The length L20 of the second MMI type optical coupling element 150-2: 525 μm
The width W20 of the second MMI type optical coupling element 150-2: 6 μm
The length L3 of the output side MMI type optical coupling unit 150T: 685 μm
The width W3 of the output side MMI type optical coupling unit 150T: 5.6 μm
The maximum width W1ᵢₙ and W2ᵢₙ of the light input side tapered part (refer to FIG. 20): 2 μm
The maximum width W2ₒᵤₜ of the light output side tapered part (refer to FIG. 20): 2 μm
The length of the light input side tapered part and the light output side tapered part: 50 μm (common)
The width W0 of the optical waveguide except for the tapered part (refer to FIG. 21): 0.8 μm (common)

### (Wavelength of Laser Light Propagating Through Light Input Side Optical Waveguide)

The wavelength of L1: 637 μm (red R)
The wavelength of L2: 455 μm (blue B)
The wavelength of L3: 520 μm (green G)

### (Distance Between Adjacent Light Input Side Optical Waveguides)

The distance d1 between the upper surfaces of adjacent tapered parts: 1.5 μm

### Example 15

Example 15 had the same model and same parameters as Example 14 except that the length L10 of the first MMI type optical coupling element 150-1 was 62 μm.

### Comparative Example 5

A model of Comparative Example 5 was the same model as and had the same parameters as that of Example 14 except that an MMI connected optical coupling unit not including the first MMI type optical coupling element 150-1 as an MMI type optical coupling incidence position shift element was used.

The coupling losses of light beams with three RGB colors of Examples 14 and 15 and Comparative Example 5 were as follows. Here, the coupling losses of light beams with three RGB colors are losses in the light intensities from when light beams are input until the light beams are output after passing through the MMI connected optical coupling unit.

The coupling losses in Example 14 were 3.2 dB, 1.5 dB, and 3.5 dB for R, G, and B, respectively.

The coupling losses in Example 15 were 3.2 dB, 1.5 dB, and 3.7 dB for R, G, and B, respectively.

The coupling losses in Comparative Example 5 were 3.2 dB, 1.5 dB, and 5.3 dB for R, G, and B, respectively.

In Examples 14 and 15, the coupling losses for RG were the same as in Comparative Example 5, but the coupling loss for blue B in Examples 14 and 15 was significantly improved compared to Comparative Example 5.

As described above, it was confirmed that, even when the MMI connected optical coupling unit was of an MMI connected optical coupling unit type, the effect of the MMI type optical coupling incidence position shift element could be obtained.

### EXPLANATION OF REFERENCES

10 Substrate
20 Optical coupling functional layer
24 Lithium niobate film
30 Visible laser light source
40 Mach-Zehnder type optical modulator
50, 50A, 50B, 150 MMI connected optical coupling unit
50-1, 50A-1, 150-1 First MMI type optical coupling element (MMI type optical coupling incidence position shift element)
50-2, 50B-2, 150-2 Second MMI type optical coupling element (MMI type optical coupling main part)
100, 101, 102, 103, 104, 110 Optical coupler
200 Optical coupling member
300 Optical coupling member with optical modulation function
1000, 2000 Visible light source module
10000 XR glasses

What is claimed is:

1. An optical coupler that couples laser light beams with a plurality of different wavelengths, comprising:
from the input side, an MMI connected optical coupling unit formed by connecting a first MMI type optical coupling element that shifts an incidence position and a second MMI type optical coupling element having a width wider than the width of the first MMI type optical coupling element;
one or more first light input side optical waveguides that are connected to the first MMI type optical coupling element;
one or more second light input side optical waveguides that are connected to the second MMI type optical coupling element; and
one light output side optical waveguide that is connected to the second MMI type optical coupling element.

2. The optical coupler according to claim 1,
wherein the first light input side optical waveguide, the second light input side optical waveguide and the light output side optical waveguide all have a tapered part whose width increases continuously toward the MMI connected optical coupling unit.

3. The optical coupler according to claim 1,
wherein the number of first light input side optical waveguides is two.

4. The optical coupler according to claim 1,
wherein the width of the first MMI type optical coupling element is ⅔ of the width of the second MMI type optical coupling element or less.

5. The optical coupler according to claim 1,
wherein the length of the first MMI type optical coupling element is 2 μm or more.

6. The optical coupler according to claim 1,
wherein the plurality of different wavelengths are all visible light wavelengths.

7. An optical coupling member, comprising:
a substrate made of a material different from lithium niobate; and
a lithium niobate film formed on the main surface of the substrate,
wherein the optical coupler according to claim 1 is formed on the lithium niobate film.

8. A visible light source module, comprising:
the optical coupling member according to claim 7; and
a plurality of visible laser light sources that emit visible light beams that are coupled by the optical coupling member.

9. An optical coupling member with an optical modulation function, comprising:
the optical coupling member according to claim 7; and
a Mach-Zehnder type optical modulator that is connected to the optical coupling member and guides a plurality of visible light beams emitted from a plurality of visible laser light sources to the optical coupler.

10. A visible light source module, comprising:
the optical coupling member with an optical modulation function according to claim 9; and
a plurality of visible laser light sources that emit visible light beams that are coupled by the optical coupler with an optical modulation function,
wherein the plurality of visible laser light sources are visible laser light sources for red light, green light, and blue light.

11. An optical engine, comprising:
the visible light source module according to claim 8; and
an optical scanning mirror that reflects light emitted from the visible light source module at different angles so that an image is displayed.

12. An optical engine, comprising:
the visible light source module according to claim 10; and
an optical scanning mirror that reflects light emitted from the visible light source module at different angles so that an image is displayed.

13. XR glasses in which the optical engine according to claim 11 is mounted.

14. XR glasses in which the optical engine according to claim 12 is mounted.

15. An optical coupling member, comprising:
a substrate made of a material different from lithium niobate; and
a lithium niobate film formed on the main surface of the substrate,
wherein the optical coupler according to claim 2 is formed on the lithium niobate film.

16. An optical coupling member, comprising:
a substrate made of a material different from lithium niobate; and
a lithium niobate film formed on the main surface of the substrate,
wherein the optical coupler according to claim 3 is formed on the lithium niobate film.

17. An optical coupling member, comprising:
a substrate made of a material different from lithium niobate; and
a lithium niobate film formed on the main surface of the substrate,
wherein the optical coupler according to claim 4 is formed on the lithium niobate film.

18. An optical coupling member, comprising:
a substrate made of a material different from lithium niobate; and
a lithium niobate film formed on the main surface of the substrate,
wherein the optical coupler according to claim 5 is formed on the lithium niobate film.

19. An optical coupling member, comprising:
a substrate made of a material different from lithium niobate; and
a lithium niobate film formed on the main surface of the substrate,
wherein the optical coupler according to claim 6 is formed on the lithium niobate film.

20. A visible light source module, comprising:
the optical coupling member according to claim 15; and
a plurality of visible laser light sources that emit visible light beams that are coupled by the optical coupling member.
